(19) United States
(12) Patent Application Publication
(10) Pub. No.: US 2025/0342656 A1
(43) Pub. Date: Nov. 6, 2025

(54) SYSTEMS AND METHODS FOR EXTENDED REALITY MULTIUSER WATCH PARTIES

(71) Applicant: Adeia Guides Inc., San Jose, CA (US)

(72) Inventors: Christopher Phillips, Hartwell, GA (US); Reda Harb, Tampa, FL (US)

(21) Appl. No.: 18/652,553

(22) Filed: May 1, 2024

(51) Int. Cl. G06T 17/00; G06F 3/14

(52) U.S. Cl. CPC G06T 17/00; G06F 3/1454

(57) ABSTRACT

Systems and methods are described for establishing a watch party between a host XR device and a plurality of remote XR devices that includes sharing a replica of the host's environment with the remote user to provide a perception of the host and remote XR devices consuming content from multiple displays together at the host's location. The sharing of the replica is based on restrictions and preferences of both the host and the remote XR devices. The methods generate and share a spatial map for the host's room, which includes a mapping of all objects and displays in the spatially mapped room. Metadata associated with content items displayed on the displays in the spatially mapped room are shared with the remote XR devices. The remote XR devices are able to access the shared content based on their subscription status with the service providers that offer the shared content item.

### FIELD OF DISCLOSURE

Embodiments of the present disclosure relate to establishing a watch party between a plurality of remote extended reality devices that includes sharing displays (both physical and virtual displays) and a virtual map of the host environment to create a 3D effect that provides a perception of the users associated with the remote extended reality devices physically watching content displayed on the displays together and in the same enclosed space.

### BACKGROUND

In the olden days, watching a movie, or any other type of media asset, together with family and friends required everyone to be physically together in the same room or space and watching the movie on a single physical television. Advances in technology and streaming removed this physical presence requirement and introduced watch parties where users at different locations could still watch a movie together without having to be physically present in the same room and consuming content on the same physical television.

The current state of a watch party allows synchronized viewing between a plurality of remote users that are not physically in the same location. The remote users can simultaneously watch movies, or other streaming content, and share their reactions via chat and other features. Such watch parties create a communal experience while still allowing remote users the comfort of consuming the content from their own locations rather than having to physically meet in one place.

Companies like Netflix™, Amazon™, Hulu™, Apple™, and many others offer the ability for remote users to watch content together while they're in different locations. Many sports fans watch games together and interact on social media or even on phone calls while watching their favorite teams play together. Today, this is done using physical devices (such as physical TVs or tablets) with connected devices running applications supporting the watch party.

One example of a current state of technology involved in a watch party is the watch party introduced by Apple in its iOS 15™ and MacOS Monterey™. Using this application and interface, remote users can share their screen and add other users to watch the same content at the same time with them.

Other examples of watch parties that provide real-time experiences require synchronization technology for their implementation. The synchronization technology allows remote users to watch the same content, at the same time, at the same pace.

Although watch parties in their current state bring people together, the technology and feature capability provided, which are still in their early stages, have several limitations. For example, in a sports setting, sports fans enjoy watching multiple games that are played at the same time. They like to track different NBA™ playoffs, NCAA March Madness™, and NFL™ games simultaneously and wish to watch them together with their family and friends. The current state of technology, however, is limited and does not provide a platform for watching multiple games or consuming multiple sources of content in a watch party setting at the same time.

Thus, another limitation with the current technology is that it permits only media that is being consumed on a single screen, single channel, or single video on demand (VOD) to be shared in a watch party setting. If multiple sources of media are presented on multiple screens, such as on a physical TV, over-the-top (OTT) streaming content on a tablet, or multiple TVs, these cannot be shared in a watch party setting.

Yet another limitation with some of the current watch parties is that they require simultaneous consumption, where all the remote users are to consume the shared content at the same time. Since all the users in a watch party may not be able to consume the content at the same time due to various reasons (e.g., being busy, working, sleeping, doing chores, etc.), they may not be able to participate in such a watch party, or if they do participate, they may miss out on key portions of the content if they are not able to consume it at the same time and pace as a host of the watch party.

As such, there is a need for systems and methods that overcome some of the above imitations and offer more enhanced feature capability for a watch party.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale. Various objects and advantages of the disclosure will be apparent upon consideration of the following detailed description, taken in conjunction with the accompanying drawings, in which like reference characters refer to like parts throughout, and in which:

FIG. 1 is a block diagram of a process for establishing a watch party and sharing content being consumed by a host, and the host's spatial environment, with remote extended reality devices in the watch party, in accordance with some embodiments of the disclosure;

FIG. 2 is a block diagram of a system for establishing a watch party and sharing content being consumed by a host, and the host's spatial environment, with remote extended reality devices in the watch party, in accordance with some embodiments of the disclosure;

FIG. 3 is a block diagram of an extended reality device, in accordance with some embodiments of the disclosure;

FIG. 4 is an example of an extended reality headset used by the host and remote users, in accordance with some embodiments of the disclosure;

FIG. 5 is an example of architecture used in a multiple display watch party, in accordance with some embodiments of the disclosure;

FIG. 6 is flowchart of a process for establishing a watch party and sharing content being consumed by a host, and the host's spatial environment, with remote extended reality devices in the watch party, in accordance with some embodiments of the disclosure;

FIG. 7 is a block diagram of an example of spatial mapping options, in accordance with some embodiments of the disclosure;

FIG. 8 is an example of a spatially mapped room with objects and displays, in accordance with some embodiments of the disclosure;

FIG. 9 is flowchart of a process for generating a spatially mapped room, in accordance with some embodiments of the disclosure;

FIG. 10 is an example of zones within a spatially mapped room, in accordance with some embodiments of the disclosure;

FIG. 11 is flowchart of a process for selecting content for a multi-user watch party, in accordance with some embodiments of the disclosure;

FIG. 12 is a block diagram of an example of host and remote user restrictions for sharing and receiving shared content, in accordance with some embodiments of the disclosure;

FIG. 13 is a block diagram of an example of application/platform, host, and remote user preferences, options, and recommendations relating to for sharing and consuming shared digital twin, in accordance with some embodiments of the disclosure;

FIG. 14 is flowchart of a process for preloading content for the remote user that is joined into the watch party, in accordance with some embodiments of the disclosure;

FIGS. 15A and 15B are a flowchart of a process for loading digital twin and providing access to content on the displays shared in the digital twin based on remote user's subscription level, in accordance with some embodiments of the disclosure;

FIG. 16 is a block diagram of a still image being shared in the digital twin, in accordance with some embodiments of the disclosure;

FIG. 17 is a field of view (FOV) from the hosting user's XR device, in accordance with some embodiments of the disclosure; and

FIG. 18 is a block diagram of host and remote user's gaze and consumption of content on display during the watch party, in accordance with some embodiments of the disclosure.

### DETAILED DESCRIPTION

In accordance with some embodiments disclosed herein, some of the above-mentioned limitations are overcome by enabling multiuser watch parties leveraging extended reality (XR) devices and sharing a replica of the hosting user's environment with a remote user's XR device. The shared replica includes all objects and displays that are in the same room as the hosting user. The displays in the replica may be a combination of physical and XR (e.g., virtual) displays that are located physically or virtually in the same room as the hosting user. The content items displayed on the physical or XR displays may be from multiple sources (live, on-demand, recorded content, content stored locally, etc.) and service providers (e.g., multiple OTT applications). The content items displayed on the displays may be content items currently being consumed by the hosting user and the remote user may also consume the same content, which is also part of the shared replica, either at the same time as the host or by time shifting to watch at a later time. The shared replica, also referred to as a digital twin, when consumed on the remote user's XR device creates a perception of the host and the remote users physically watching the content together in the same room or space.

In some embodiments, the host, using the host XR device or another electronic device, may create a multiuser watch party by inviting remote users to join the watch party. As used herein, extended reality refers to augmented reality, virtual reality, mixed reality, and any combination thereof. Once the remote users accept the invitation, they become participants in the watch party. The remote users, using their XR devices, may then be able to view a replica (digital twin) of the hosting user's environment, which includes physical TV(s)/displays and the virtual TVs all positioned at the exact locations and playing the same content as the host of the multiuser watch party. Although references are made to a TV, this also include any other type of display device, media device, or a display screen. Collectively, any physical display, such as a TV, media device, projector screen, laptop screen, mobile phone screen, home assistant screen (such as an Amazon Echo™ screen), will be referred to herein for simplification as a physical display.

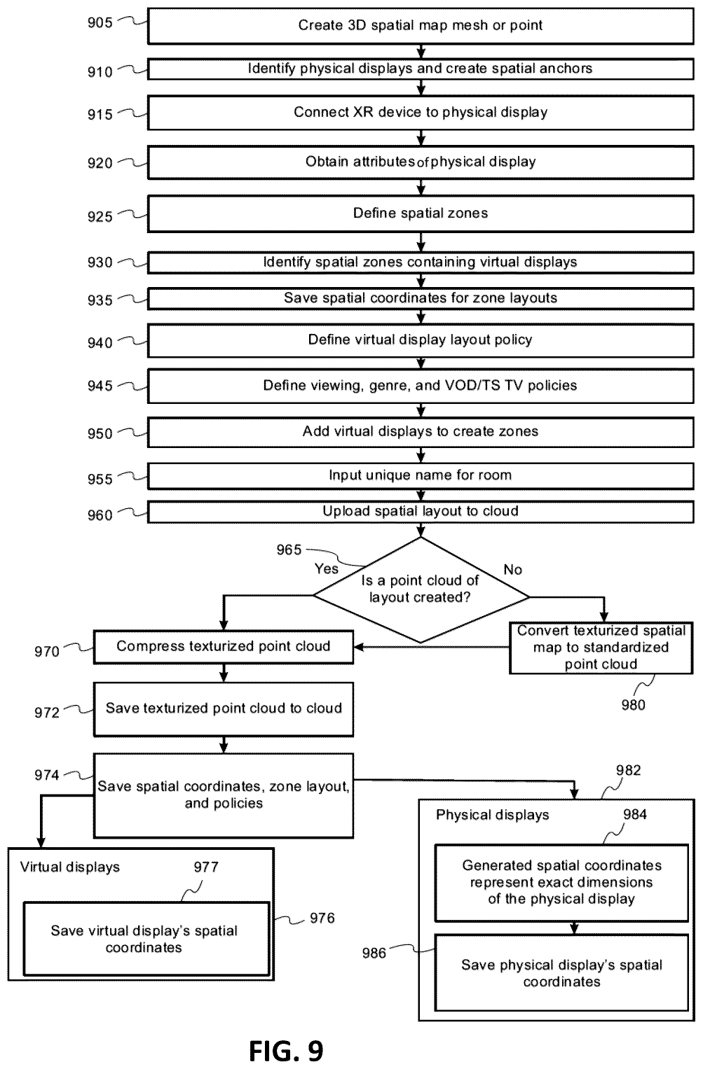

To implement such a watch party, an XR device used by the hosting user (also referred to as a host or host XR device) may generate or obtain a spatial map of the room where the host is located during the watch party. In some embodiments, the spatial map may already be created when the host initiates the watch party. In other embodiments, the spatial map may be generated after the watch party is initiated. An example of a process of how the spatial map is generated is described further in the description related to FIG. 9. In addition to the description of FIG. 9, in some embodiments, the spatial map may also be generated by an augmented reality headset worn by the host. The spatial map identifies a spatial location of all (or one or more) objects, physical displays, and virtual displays in the room and spatially anchors them to a selected spatial anchor. This spatial map may also include a spatial anchor (e.g., coordinates) for each physical and virtual display in the spatially mapped room. The spatial map may be a texturized 3D mesh or point cloud representation of hosting user's room. The spatial map may include coordinates of all displays and objects in the room or the confined space (hereinafter referred to as “room”) in which the hosting user is located during the watch party, at the launch of the watch party, or a majority of time during the watch party. This includes coordinates and location of each object, display, person, or any item or structure within the room. The spatial map may also include zones that subdivide the room into a plurality of zones. For example, zones may be generated based on genre. Zones may also be generated based on bandwidth required to transmit each zone to a remote user, bandwidth and resources needed at remote user's site to render each zone, etc. Zones may also be generated based on what is private to the hosting user and what can be shared. If the zone or an object is private, it may be masked such that it is not shown to the remote XR device (e.g., masking may include overlaying with another object or in-painting with a background). All spatial coordinates, spatial zones, and any spatial zone policies associated with each spatial zone, and the spatial map, may be stored to a cloud server associated with the hosting user's account. A virtual representation may be created for any physical displays/devices, and the spatial coordinates and spatial tags for such physical displays/devices may be saved to the cloud server. In addition to physical displays and devices, spatial coordinates and spatial tags for virtual displays may also be saved to the cloud server associated with the hosting user's account. In one embodiment, these physical displays/devices and virtual displays may be only those physical displays/devices and virtual TVs/displays that are visible through the field of view (FOV) of the XR device used or worn by the hosting user. In another embodiment, these physical displays/devices and virtual displays may be any physical displays/devices and virtual TVs/displays that are in the same room as the hosting user's XR device during the watch party.

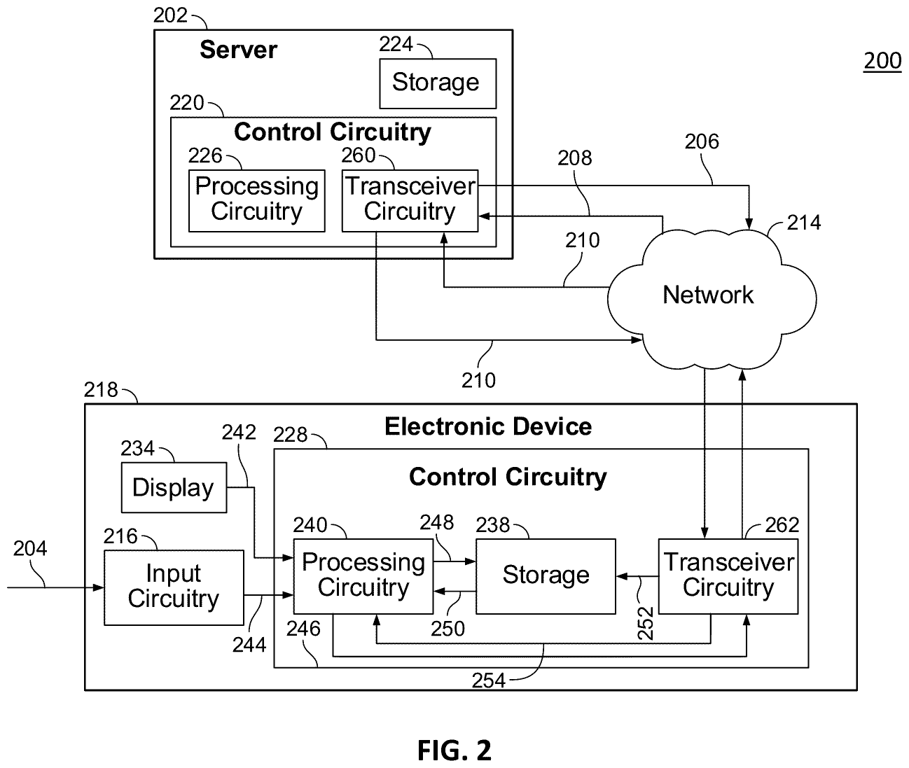

In some embodiments, once the room has been spatially mapped, the control circuitry, such as control circuitry 220 and/or 228 of FIG. 2, may map the coordinates of the displays (and other objects in the room) with respect to the location of the host's XR device. Such mapping may allow the control circuitry 220 and/or 228 to determine depth perception and a relative distance and orientation between the displays (and other objects in the room) and the hosting user's XR device, i.e., where the displays are located and oriented in the spatially mapped room is relative to where the XR device is located. This depth perception and relative distance and orientation may be used to replicate the hosting user's environment, which includes the objects and displays (i.e., the digital twin) at the same depth, distance, and orientation on the remote user's XR device.

The digital twin, which includes the spatial map, spatial anchors, physical displays/devices and virtual TVs/displays, and all other objects, people, and any item or structure within the room of the hosting user, may be shared with the remote XR device associated with the remote user that has become a participant in the watch party. In some embodiments, although the entire digital twin that displays a replica of the hosting user's environment may be shared, only a portion of the digital twin that is visible through the FOV of the XR device may be rendered on the remote XR device associated with the remote user. In one embodiment, sharing the exact digital twin of the hosting user's room, which includes all physical displays and AR virtual TVs in the spatially mapped room, allows the remote user to view any portion of the digital twin, regardless of whether the portion of the spatially mapped room is in the FOV of the hosting user's XR device. In another embodiment, sharing the exact digital twin of the hosting user's room, which includes all physical displays and AR virtual TVs in the spatially mapped room, may allow the remote user to view everything that the hosting user is currently viewing in their FOV through the remote user's XR device. In some embodiments, sharing and viewing restrictions, hosting user and remote user profiles, and other considerations and sharing factors may be considered in determining which portion or content from the digital twin is to be shared with the remote user. If the entire digital twin is shared with the remote user, then sharing and viewing restrictions, hosting user and remote user profiles, and other considerations and sharing factors may be considered in determining which portion or content from the digital twin is to be rendered on the remote user's XR device. Consumption of the shared digital twin may allow the hosting user and the remote user a perception that they are physically together, e.g., in the same room that the hosting user is in. The remote user is then free to view any portion of the digital twin, regardless of whether it is in the FOV of the hosting user's XR device. For example, while the hosting user may be looking at one portion of the digital twin, such as a left side, the remote user may be looking at a different portion of the digital twin, such as the right side of the same spatially mapped room. In another embodiment, the remote user may be restricted to consuming the same content visible in the FOV of the hosting user's XR device or looking at the same direction as the host user. For example, if the host is watching, via their XR device, the Superbowl on a physical TV in their room and a basketball game on a virtual TV visible in their XR device, then the exact same displays, in the same orientation, depth perception, along with everything the host may be able to see in their FOV via the XR device, may also be visible to the remote user. As such, the host and remote user may be provided with a feel of consuming the Superbowl and the basketball game while being in the same room (when in reality the remote user may be miles away from the host).

In some embodiments, metadata of all content on the displays in the spatially mapped room may be shared when sharing the digital twin. The remote user may then access such content by communicating with the service provider of the content, such as by selecting a link shared in the metadata. If the remote user's subscription level with the service provider allows consumption of the content, then the remote user may be able to access and consume the content. In this embodiment, it is possible that the host may be viewing a separate content item, whatever is in the host's FOV of their XR device, and the remote user may be consuming a different content item that is displayed on a different display also in the same spatially mapped room that is shared as part of the digital twin.

In other embodiments, sharing the content displayed on a display (e.g., physical, or virtual display) that is part of the digital twin may comprise sharing metadata of the content being consumed by the hosting user on the display. For example, a hosting user may be wearing an AR device, and one physical display and one virtual TV may be visible in the FOV of the AR device. Content playing on the physical display may be an NFL game and content playing on the virtual TV may be the movie “The Last Duel.” When the digital twin (which includes objects and displays visible in the FOV of the hosting user) is shared, metadata associated with the NFL game and the movie “The Last Duel” may be shared with the remote user. Metadata may include the title of the content, source (e.g., Netflix, Epix, Linear channel, etc.), type (e.g., live, on-demand, recorded content such as cloud-based recording), universal ID (which allows retrieval of the content from a different application that the host is using), etc. If the remote user's policies do not restrict the remote user from consuming the content associated with the shared metadata, then the control circuitry 228 at the remote user's end may determine whether the remote user has a subscription with the respective content providers that allows the remote user to consume the content associated with the shared metadata. If the remote user is subscribed, then the content will be played on a screen of the XR device worn by the remote user. The format of the content displayed on the remote user's XR device may be a digital twin of the image viewable from the FOV of the hosting user's XR device. In some embodiments, the host is aware before starting the watch party of which content items that they're currently consuming on the various displays (e.g., physical and virtual displays). The same content can be consumed by one or more participants. This is possible if one or more of the participants share their subscription data (i.e., with media sources and apps they are entitled to watch) with the “Watch Party” service or the host.

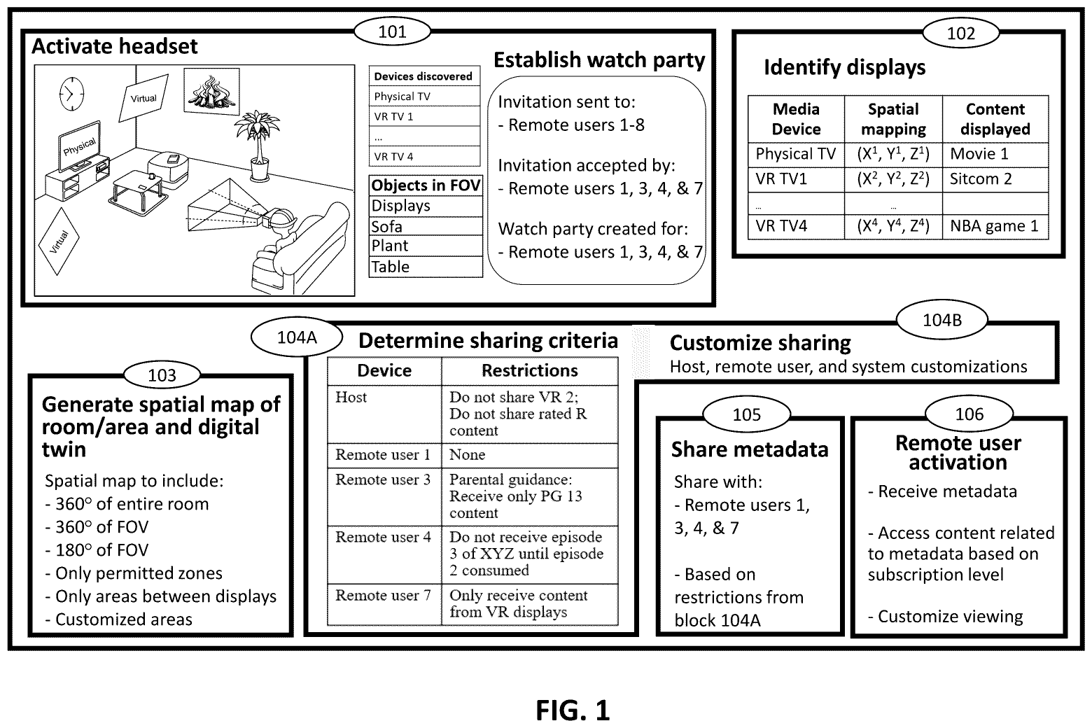

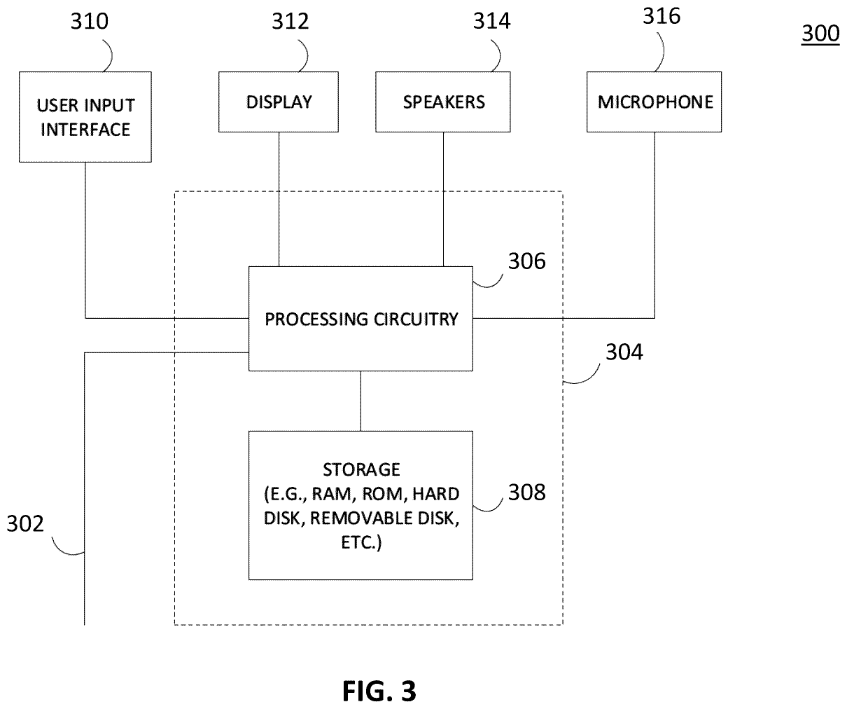

Referring to the figures, FIG. 1 is a block diagram of a process 100 for establishing a watch party and sharing content being consumed by a host, and the host's spatial environment, with remote XR devices in the watch party, in accordance with some embodiments of the disclosure. The process 100 may be implemented, in whole or in part, by systems or devices such as those shown in FIG. 2-3. One or more actions of the process 100 may be incorporated into or combined with one or more actions of any other process or embodiments described herein. The process 100 may be saved to a memory or storage (e.g., any one of those depicted in FIGS. 2-3) as one or more instructions or routines that may be executed by a corresponding device or system to implement the process 100.

In some embodiments, at block 101, the process may be initiated when a hosting user turns on or activates their extended reality headset. In other embodiments, the hosting user may select one or more options in their extended reality headset to initiate the process of hosting a multiuser watch party. The hosting user may also initiate the process using another electronic device, such as a laptop, tablet, etc.

In some embodiments, the hosting user may be sharing the entire digital twin and in other embodiments, although the entire digital twin is shared, the hosting user may restrict the remote user to what is currently visible in the FOV of the hosting user's XR device. All the embodiments listed herein may be applied to either of the two scenarios. In the embodiment where the host XR device creates the texturized mesh or point cloud of the room, i.e., digital twin, that is uploaded to the cloud to pre prep the XR watch party's digital twin of the room, the remote user's XR device may be able to access the digital twin from the cloud and preload it on to the remote user's XR device. In other embodiments, the hosting user may be wearing an XR device. Likewise, a remote user that has become a participant in a watch party may also be wearing an XR device. The XR device, also referred to as an XR device, may be an extended reality headset, such as a virtual reality, augmented reality, or mixed reality headset, worn by the hosting user. The extended reality headset may be a head-mounted XR device. It may be a device that can be worn by the hosting user by wrapping it around their head, or some portion of their head, and in some instances, it may be encompassing the entire head and the eyes of the user. Through the extended reality headset or XR device, the hosting user may be able to view in their FOV both real-life objects, such as a physical display set(s) or a media device(s), living room or other space in which the hosting user is located, including objects in the living room in their FOV, and all virtual displays and TVs and any virtual objects that are virtually visible in their FOV.

The virtual content visible via the host XR device is content that is not in the real or physical world and exists only in a virtual world. It may be a virtual content item such as a virtual TV, virtual screen, a virtual object, etc.

In some embodiments, the XR device may be a non-headset device. For example, the XR device may be a wearable device, such as smart glasses with control circuitry, that allows the hosting user to see through a transparent glass to view physical and virtual displays and TVs. Such see-through devices may use optical or a video see-through functionality. In other embodiments, the XR device may be a mobile phone having a camera and a display to intake the live feed input and display it on a display screen of the mobile device. The devices mentioned may, in some embodiments, include both a front-facing or inward-facing camera and an outward-facing camera. The front-facing or inward-facing camera may be directed at the user of the device, while the outward-facing camera may capture the live images in its field of view, such as the physical displays in the hosting user's room and all physical objects in the host XR device's FOV. The devices mentioned above, such as smart glasses, mobile phones, virtual or augmented reality headsets, and the like, for sake of simplification, are herein referred to as XR devices or extended reality headsets.

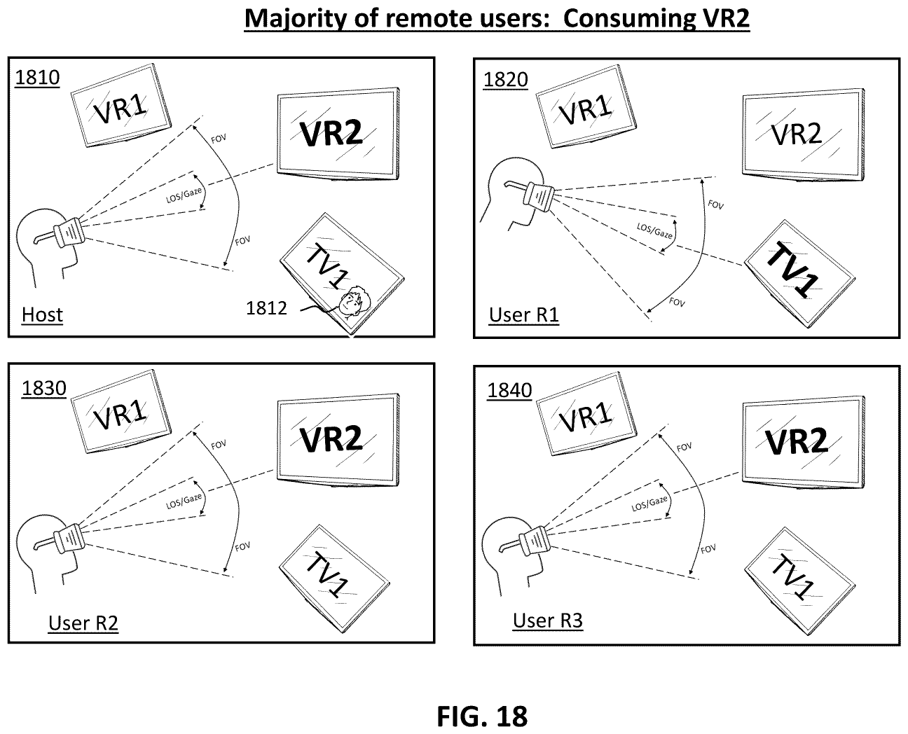

In some examples, the XR device may comprise means for eye tracking, which may be used to determine the focus of a hosting user or the remote user's gaze, thereby determining what displays are being consumed by them. For example, as depicted in FIG. 18, the eye tracking feature may be used to determine that remote user R1 1820's gaze is directed at TV1.

The FOV of the hosting user (or any remote user) may change based on the transitional and orientational position and pose of the hosting user. For example, a hosting user may rotate their head, while wearing the XR device, to their left. Such orientation may allow the hosting user to see a first set of physical and virtual TVs and objects in their FOV. Subsequently, when the hosting user turns their head to the right, those physical and virtual TVs and objects that were in the FOV when the hosting user had oriented their head to the left may no longer be in their FOV, and different physical and virtual TVs and objects may appear. To determine the current location and orientation, the control circuitry 220 and/or 228 may utilize one or more hardware components of the XR device. These components may include an inertial measuring unit (IMU), a gyroscope, an accelerometer, a camera, and sensors, such as motion sensors, that are associated with the XR device. For example, the control circuitry 220 and/or 228 may obtain the coordinates of the XR device from the IMU and execute an algorithm to compute the headset's rotation from its earlier position to its current position and represent the rotation by a quaternion or rotation matrix. In some embodiments, the gyroscope located in the IMU may be used by the control circuitry 220 and/or 228 to measure the angular velocity or the rotation. In this embodiment, the control circuitry 220 and/or 228 may use the angular velocity at which the XR device has rotated to compute the current orientation.

Based on the current location of the XR device, the control circuitry 220 and/or 228 may determine the FOV from the headset. The FOV may allow the control circuitry 220 and/or 228 to determine which displays fall within the FOV of the XR device based on its current location and orientation and which displays are outside the FOV. In some embodiments, the XR device's FOV may be determined at an operating system level at the XR device, and in other embodiments, it may be determined via an application (app) running on the XR device. In yet other embodiments, the FOV may be determined at a location remote from the XR device, for example at a server.

In some embodiments, the control circuitry 220 and/or 228 may determine an angle of the FOV. Such angle determination may allow the control circuitry 220 and/or 228 to determine where the spatial tag for physical displays or the extended reality displays falls in the FOV. For example, if a spatial tag of a display is located at the center of the display and the spatial tag coordinates are within an angle of the FOV, then the control circuitry 220 and/or 228 may determine that the display is in the FOV. In other embodiments, if the special tag is at a corner of the display, even though some portion of the display may be in the FOV, if the spatial tag is not in the FOV, then the control circuitry 220 and/or 228 may determine that the display is not in the FOV. The control circuitry 220 and/or 228 may also make determinations whether the display is partially or fully in the FOV based on the angle.

In some embodiments, only a physical display associated with a media device may fall within the FOV of the user. In other embodiments, only a virtual TV or display may fall within the FOV of the user. In yet other embodiments, a combination of both one or more physical displays associated with one or more physical display or media devices and one or more virtual reality displays may fall within the FOV of the user.

When a physical display falls within the FOV of the hosting user's XR device, in some embodiments, playback of respective content items, such as a live television stream, a time-shifted television stream and/or a VOD stream, a virtual representation of the physical display in the digital twin of the hosting user's spatially mapped room is displayed on the remote user's XR device. The physical display may also receive a content item via VOD or via a live television stream. The content on the physical display may be ongoing; however, in some embodiments, a digital twin that includes the physical display and the content being displayed on the physical display may be made and shared only if the physical display is in the FOV of the host XR device. In other words, if the hosting user wearing the host XR device is facing away from the physical display, although the physical display may still be in the same room as the hosting user, it may not be shared in the digital twin. In other embodiments, a digital twin that includes the physical display and metadata associated with the content being displayed on the physical display may be shared with the remote user, however, depending on the hosting user's current FOV, only portion that is in the FOV may be rendered on the remote user's XR device such that the remote user can see whatever the hosting user can see in their FOV. In this embodiment, if the physical display is no longer in the hosting user's FOV, it may not be rendered on the remote user's XR device. In other embodiments, the sharing of the digital twin is not dependent on the FOV from the hosting user's XR device. As such, if a physical display in present in the hosting user's spatially mapped room, regardless of whether the physical display is currently in the FOV of the hosting user's XR device, a virtual representation of the physical display is made available to the remote user's XR device. As such, when the remote user's XR device orients in the direction of the physical display, the virtual representation of the hosting user's physical display is displayed to the remote user. In other words, the remote users will only see a virtual representation of the physical display along with the content the hosting user is playing on their physical display on their display (i.e., on the XR device of the remote user's display), which is a virtual replica of digital twin of the hosting user's physical display.

In some embodiments, the host XR device may directly receive a content item via a live multicast adaptable bitrate stream or an OTT stream. It may also receive content from an electronic device to which it is communicatively connected, such as via a Bluetooth connection. This may be displayed as virtual content on a screen of the host XR device and may not be visible outside of the host XR device. Such content (i.e., virtual content on a screen of the host XR device) may also be part of a digital twin that may be generated and shared with other remote XR devices that have become participants in the watch party.

At block 101, once the process to host a watch party is initiated, the host XR device may send a request to intended remote XR devices to join the watch party. The host XR device may access a contact list saved in their profile associated with the host XR device or a contact list saved in any of the host's devices, such as their smart phone, to select individuals and transmit the request to join. In some embodiments, the setting from a previous watch party may be saved and the same setting may be used to send an invitation for a current watch party. For example, the host may have previously established a watch party where the host consumed episode 1 of a series with certain friends and family members. Subsequently, when the host initiates a second watch party, the system (such as the system in FIG. 2) may automatically detect that one of the displays in the FOV of the host XR device is displaying episode 2 of the same series. Accordingly, the system may automatically suggest the same members of the earlier watch party be invited to the current watch party.

In this example, as depicted in block 101, invitations to join the watch party may be sent to remote users 1-8. Some of the remote users, i.e., users 1, 3, 4, and 7, may accept the invitation to join the watch party. Once an acceptance(s) is received, a watch party may be created with those remote users that have accepted to join the watch party.

At block 102, in one embodiment, the host XR device, or the control circuitry, such as control circuitry 220 and/or 228 of the system depicted in FIG. 2, may identify displays that are available in the room where the hosting user is located. In another embodiment, the control circuitry may identify displays visible from the FOV of the host XR device. In one embodiment, these displays may include a mix of both physical and virtual displays such as physical TV and virtual reality (VR) TVs 1-4. In another embodiment, the displays may include only physical displays or only virtual displays. In one example, all displays in the hosting user's spatially mapped room may be shared as a digital twin, regardless of whether the displays are currently in the FOV of the hosting user's XR device (e.g., even if the host leaves the room designated for the watch party for a certain time frame). In another example, depending on the orientation of the hosting user's XR device, the FOV may change and the displays visible in the FOV may also change as the orientation changes and only those displays that are in the FOV may be shared with the remote user.

The control circuitry 220 and/or 228 may also generate a spatial mapping of each of the identified displays. The spatial mapping may be a set of coordinates that may be from a selected origin, such as an arbitrary origin, or it be anchored to an object visible in the FOV of the host XR device. As depicted at block 101, in one embodiment, a mix of physical televisions and virtual televisions located in a host's spatially mapped room may be visible from the host XR device. The spatially mapped room may also include different zones. The zones may be arbitrary or may be predetermined based on certain criteria. For example, in some embodiments, each zone may be associated with a different display or type of display (e.g., physical displays may be separated in a different zone from virtual displays). Zones may also be subdivisions of the room in which the hosting user is located during the hosting of the watch party. Zones may also be based on bandwidth consideration, e.g., an area that has multiple displays may be split into two zones such that an assessment of amount of bandwidth required to display each zone can be calculated and decisions to generate the digital twin including bandwidth-intensive zones can be made. Zones may also be associated with a specific genre, such as sports, art, people, news, etc. Such zoning may be identified by the hosting user or automatically created by the XR device or control circuitry 220 and/or 228 based on analyzing the room and what objects and displays are in it. The XR device or control circuitry may also leverage an AI engine to get recommendations for genres based on a camera input fed into the AI engine and accordingly create genre-specific zones.

Along with identifying the displays in the FOV of the host XR device, the control circuitry 220 and/or 228 may also identify the content being displayed on each of the identified displays. In some embodiments, the content being played on one display may be different from content displayed on another display. For example, the physical TV may be playing a live NBA™ game of Warriors™ vs. Lakers™, while the virtual TV may be playing a different NBA game (e.g., Bulls™ vs. Bucks™) or and NFL™ game. The host may select what content is to be played on which physical and virtual displays and may change it as desired. A sports enthusiast may also play different games of a same competition on different displays so they can track how each team is performing. While sports are just one example, content relating to any other genre or different genres may be displayed on different displays visible in the FOV of the host XR device.

At block 103, a spatial map of the room or an area where the host XR device is located may be generated. In some embodiments, the host XR device's built-in sensors with RGB cameras, IR cameras and possibly LiDAR, may be used to generate an exact spatial map/layout. The spatial map/layout may either be created on the host XR device (e.g., an AR device) or in the cloud, such as by a cloud server associated with the host XR device. The spatial map generated may be enhanced with texture overlays, also known as a texturized 3D spatial map, of the hosting user's room. Further details of creating a spatial map/layout are described in relation to FIG. 9 below.

The spatial map/layout generated includes the exact dimensions and locations of all the displays and objects in the room where the host XR device is located. In some embodiments, the spatial map/layout may include a 360° view of the room where the host XR device is located. In other embodiments, the spatial map may be created for a portion of the room, such as 180 from the FOV of the host XR device, only permitted zones, areas between the two farthest displays, or other customized areas.

The spatial map/layout generated may also include spatial anchors. The objects, displays, and all visible items, such as in the FOV of the host XR device, may be tied to a selected spatial anchor. The spatial anchoring may be used to determine the exact locations of the displays as defined by the spatial anchor coordinates.

Once the spatial map/layout is generated, it may represent an exact replica of the spatially mapped room including all physical and virtual displays (e.g., TVs) with the exact sizes and dimensions of the displays as in the hosting user's room. All zones may also be placed at the exact spatial coordinates in the hosting user's physical room. All zone locations along with the zone policies may also be replicated in the virtual environment. All virtual displays within a zone in the virtual space may also adhere to the layout defined by the hosting user's zone in the physical space. In some embodiments, once the spatial map/layout coordinates are generated, they may be shared by the host with a remote user that has joined the watch party. The spatial map/layout coordinates may be loaded (e.g., to a cloud-based service), rendered, and made available to the participants in the watch party.

In one embodiment, as described earlier, a digital twin may be generated using the spatial map/layout and texturized mesh or point cloud. The generated digital twin would include a replica of the host's environment. In this embodiment, the digital twin of the hosting user's spatially mapped room may be made available to the remote user. Once made available, regardless of the hosting user's current view from the host's XR device (i.e., the FOV from the host's XR device), including if the host leaves the room entirely, all remote user XR devices may be able to view the entire digital twin of the spatially mapped room, including all TVs virtual or physical that are located in the hosting user's spatially mapped room. In some embodiments, the host may designate a room for the watch party, such as their family or living room that has a physical television, then upon the launch of the watch party, the host may temporarily leave the designated room, such as to get some food from the kitchen, go to the bathroom, attend a work call for a few minutes, etc. Once the room for the watch party is designated, and then spatially mapped, a replica of the spatially mapped room, which is the room designated by the host for the watch party, is made available to the remote user even when the host leaves the room temporarily. In some instance, the host may also set a timer of how long the host can be away from the designated room for the watch party to continue without them.

In another embodiment, the digital twin may be shared with the remote user but the remote user receiving the digital twin may be restricted to what the host is able to view in the FOV of the host XR device. In either of the two embodiments, i.e., making the entire digital twin of only a portion of the digital twin (e.g., portion in FOV of host XR device), once shared, digital twin would include all displays, content displayed on each display, objects in the environment, in the exact locations in the host's spatially mapped room. In the embodiment where the remote user is restricted to only see what is in the FOV of the host XR device, if the orientation of the host XR device changes, whatever is in the FOV after the orientation change would also be visible in the digital twin. The digital twin may also include a hologram or avatar of a remote user that is joined into the watch party. One method of using the hologram would be to place the hologram of a remote user in the FOV of the host XR device such that the host may get a perception of the remote user physically being present in the room (via the hologram) to provide the communal feel. An avatar may also be displayed in the virtual environment visible in the FOV of the host XR device to indicate which remote user is engaged with the watch party and what display they are currently consuming. All, or a portion, of the digital twin created may be shared with the remotes users joined into the watch party based on sharing restrictions.

At block 104A, the control circuitry 220 and/or 228 may determine sharing criteria for sharing the digital twin and/or the spatial map/location. Sharing may involve, in some embodiments, determining sharing restrictions of both the hosting user and the receiving remote user joined into the watch party. Further customization based on hosting user, remote user, and system options and preferences are described in block 104B. All such sharing criteria, restrictions, and customizations may be considered in generating a customized digital twin for each remote user.

In some embodiments, the host may have certain restrictions of what content or portion of their room they would like to share with other remote users that are joined into the watch party. This embodiment may be independent of the hosting user's current FOV thru their XR device. For example, the host may not want to share content displayed on all their displays that are visible in the FOV of their host XR device. In some instances, the members of the watch party may include family, such as parents, and in other instances they may include colleagues from work or friends. The host may place restrictions in their profile of the XR device of what type of content can be shared with the remote users based on the type of relationship between the host and the remote user. For example, if the host is consuming R-rated content on one of the displays in the FOV of the host XR device, then the host may not want to share such content with their parents or colleagues.

In addition to restrictions on what type of content the host would like to share with others in the watch party, the host may also have restrictions as to what objects that are visible in the FOV of the host XR device that the host would not want to share with the remote users. This may also include any people that are visible in the same room as the host that the host may not want to make visible to others. In such instances, the host may identify the objects or zones that they would not like to share in the watch party. Accordingly, the control circuitry 220 and/or 228 may eliminate those objects in the digital twin. To eliminate such restricted objects/people, the control circuitry 220 and/or 228 may apply an in-painting technique. For example, the control circuitry 220 and/or 228 may in-paint over the restricted object with the background such that the object is not visible in the digital twin. The control circuitry 220 and/or 228 may also use any other technology, such as technology used by mobile phones to erase people/objects in a photograph, to remove the restricted objects/people from the digital twin such that those objects/people are not visible to others when the digital twin is shared.

In some embodiments, the remote user who is joined into the watch party may also have their own restrictions. For example, these restrictions may include parental restrictions that would prevent certain content from being displayed in the XR device worn by the remote user. The remote user may also have other restrictions such as “Do not receive episode #3 of XYZ series episode #2 consumed.”

Some other examples of the host and remote user restrictions are also depicted in block 104A. In one example, the host may not want to share the virtual display VR2 or any content that is rated R with the remote users that are joined into the watch party. Since the host may actually be sharing metadata rather than the content itself, the host may not want to share metadata associated with whatever is displayed on virtual display VR2 or any other type of display if the content is rated R.

In another example, the remote user, such as remote user 1, may have no restrictions at all on what type of content they wish to receive as part of the watch party. Remote user 3, on the other hand, may have parental guidance restrictions that indicate they wish to “only receive PG 13 content,” based on which only metadata of content that is PG 13 may be shared with them. Remote user 4 may not want to receive episode 3 until they have consumed episode 2 (as such metadata associated with episode 3 may not be shared until a determination is made that episode is consumed), while remote user 7 may only want to receive metadata for content displayed on the virtual displays and not on the physical displays. All host and remote user sharing and receiving criteria may be customized to their liking.

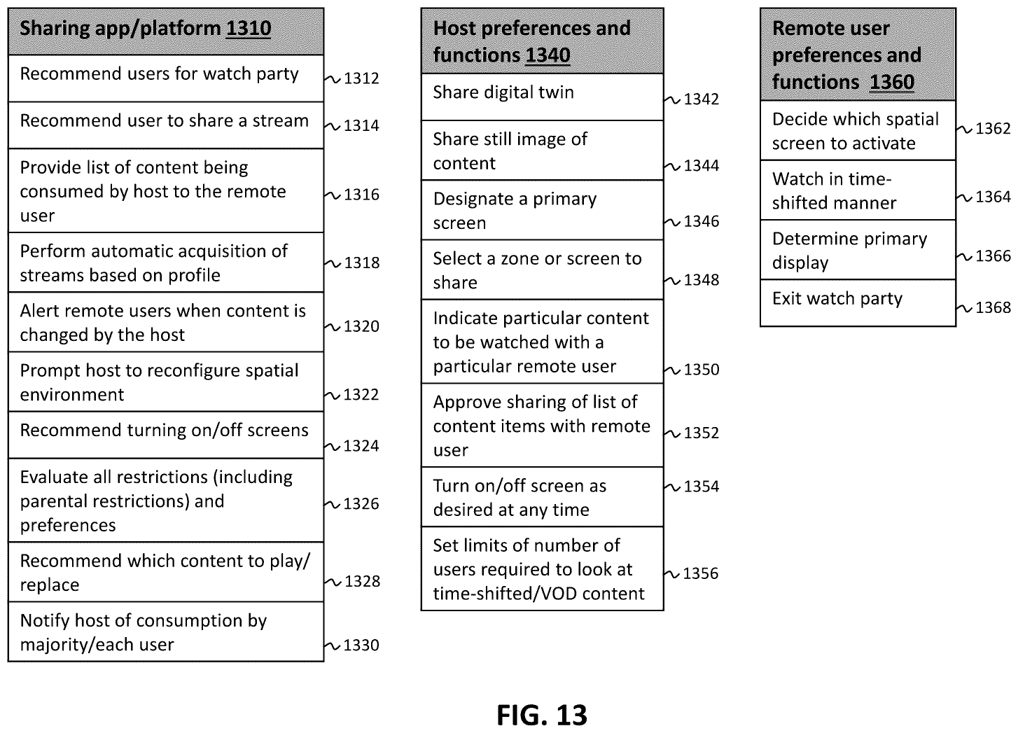

At block 104B, the sharing of the digital twin may be customized. These customizations may be based on preferences of the hosting user associated with the host XR device or a remote user associated with a remote XR device or based on sharing app options and recommendations. Some examples of the customizations are provided in FIG. 13.

With respect to the host, some customizations based on the host preferences, which may be indicated in the host profile or based on machine learning data related to prior selections by the host XR device in prior watch parties, may include sharing the entire digital twin with every remote user. In other embodiments, based on host preferences and prior watch party data, only certain portions of the digital twin may be shared with host XR devices of remote users. In yet other embodiments, the host may designate a primary screen, select a zone or a screen for sharing, or indicate particular content that is to be watched with a particular remote user during the watch party. In yet other embodiments, during the watch party, the host may turn on or off a screen as desired at any time, for any duration. The host may turn on/off a display/screen for the entire watch party or specifically for a particular remote user. In yet other embodiments, the host may want to share a list of content with the remote users, and in other embodiments, the host may want to share the list of content only with a particular remote user or not share it at all. And in yet other embodiments, the host may set limits of the number of users that are required to look at time-shifted/VOD content.

With respect to the remote user joined into the watch party, some customizations based on the remote user preferences, which may be indicated in the remote user profile or based on machine learning data related to prior selections by the remote XR device in prior watch parties, may include determining which spatial screen to activate. In other embodiments, customizations may allow the remote user to make selections and decide which shared display to watch, and whether to watch it in real time or in a time-shifted manner. The remote user may also determine a primary display and decide to make the primary display a main focus of their watch party experience. The remote user may also exit the watch party at any time.

Customizations may also be based on the sharing app/platform's recommendations and options. These recommendations may be based on results from a machine learning or an artificial intelligence engine executing a machine learning or artificial intelligence algorithm. In some embodiments, the sharing app/platform may recommend to the hosting user to share a particular stream. In other embodiments, the sharing app/platform may recommend remote users to invite for the watch party. In another embodiment, the sharing app/platform may provide a list of content being consumed by the host to the remote users during the watch party or prior to them joining the watch party. Such sharing of content, in some embodiments, may be provided after the hosting user approves sharing such lists. In yet another embodiment, the sharing app/platform may perform automatic acquisition of streams based on the host or remote user profiles. In yet another embodiment, the sharing app/platform may alert remote users when content is changed by the host, such as by using the host XR device. In yet another embodiment, the sharing app/platform may prompt the host to reconfigure their spatial environment. The recommendation may also be to turn on and off certain screens and displays. The sharing app/platform may also evaluate all restrictions, preferences and customizations, including parental restrictions, prior to sharing a digital twin with their remote user. In some embodiments, the sharing app/platform may recommend to the host which content to play and/or replace. The sharing app/platform may also notify the host via the host XR device of the consumption by a majority of the remote users or specifically for each remote user. Additional details relating to host, remote user, and the sharing app/platform preferences and customizations are discussed in relation to FIG. 13 below.

At block 105, the control circuitry 220 and/or 228 may share metadata of content displayed on those displayed devices that are visible in the FOV of the host XR device based on the host and remote user restrictions determined at block 104. Since each remote user joined into the watch party may have different set of restrictions, the digital twin shared with each remote user may differ and be customized based on their restrictions.

At block 106, a remote user may receive a digital twin shared by the host. The digital twin received may already be customized for the remote user based on both the host's and remote user's preferences and restrictions. Some examples of customizations are described in in FIG. 13. The digital twin may also include displays in the FOV of the host XR device. With respect to the content being displayed on the displays in the FOV of the host XR device, the digital twin would include metadata that is shared with the remote user. The metadata would be associated with content displayed on the displays in the FOV of the host XR device.

To watch the same content as the host, the remote user's XR device may use the metadata, which may include a link to the content, and may query the provider of such content to obtain a content stream associated with the content. Depending on the subscription level of the remote user with the provider of the content, such content may or may not be available to the remote user. For example, in one instance, the host may be consuming the movie “The Last Duel” that is being accessed by the host using their Netflix account. The display on which “The Last Duel” is being played may be within the FOV of the host XR device. Once the host and remote user restrictions have been considered, which in one instance may allow the sharing of the movie, the digital twin shared with the remote user may include metadata for “The Last Duel.” The remote user may then query Netflix to obtain a content stream that includes the movie “The Last Duel.” If the remote user does not have a Netflix account, this may present an opportunity for Netflix to sell the remote user on getting a subscription to Netflix. If the remote user has a Netflix account and the movie “The Last Duel” is within their subscription level, then a content stream may be provided to the remote user for consumption. If the remote user has a Netflix account but to watch the movie “The Last Duel” requires an upgrade to their subscription, that may provide Netflix an opportunity to upsell the remote user on upgrading their subscription level to a higher tier. Once the remote user obtains the content stream associated with the movie “The Last Duel,” the remote user may customize their viewing experience. For example, the remote user may watch the content at the same time as the host, time-shift and watch the content at a later time or watch the content but not at the same pace as the host.

FIG. 2 is a block diagram of a system for establishing a watch party and sharing content being consumed by a host, and the host's spatial environment, with remote XR devices in the watch party, in accordance with some embodiments of the disclosure and FIG. 3 is a block diagram of an XR device, in accordance with some embodiments of the disclosure.

FIGS. 2 and 3 also describe exemplary devices, systems, servers, and related hardware that may be used to implement processes, functions, and functionalities described in relation to FIGS. 1 and 4-18. Further, FIGS. 2 and 3 may also be used for generating a watch party between a plurality of XR devices, inviting a plurality of remote users to join the generated watch party, joining the XR devices into a watch party that is hosted by a host XR device after receiving an acceptance from the remote users to join the watch party, generate a spatial map of the hosting user's environment along with a texturized mesh or point cloud, which may be the room in which the hosting user is located when the watch party is established, identifying all displays in the room (e.g., both physical and virtual displays), where the physical displays may be located in any part of the room and the virtual displays that may be within the spatially mapped room, identifying all objects and other items in the room, identifying all virtual objects that may be within the spatially mapped room, identifying coordinates and dimensions of each display, spatially anchoring the displays, such as to an arbitrary origin or to an object in the room, generating a digital twin of the displays and the host's environment leveraging the spatially mapped room, determining sharing and receiving restrictions, preferences, and other criteria, sharing metadata associated with content displayed on a display in the host's environment with the remote user subject to the sharing and receiving restrictions, preferences, and other criteria, customizing the digital twin for each remote user based on the remote user's receiving restrictions, preferences, and other criteria, displaying a clip or a still image of the content item displayed on the display in the host's environment on the remote user's XR device, determining whether the remote user has subscription with a content provider that allows the remote user to access a content item shared in the digital twin, providing subscription offers to the remote user, determining the remote user's bandwidth constraints in receiving and displaying all or portion of the digital twin, all or some of the displays from the hosting user's environment that are shared as part of the digital twin, generating zones in the spatially mapped room, sharing some of the zone based on the determined bandwidth restrictions of the remote user, preloading content on the remote user's XR device, generating avatars associated with the remote users to be displayed on the host's XR device, tracking gaze of users associated with remote XR devices that are joined into the watch party, determining consumption progress and focus of gaze of the remote users, alerting remote users of consumption by some or a majority of other remote users in the watch party, suggesting sharing content to the hosting user, generating texturized point cloud, generating spatial tags, determining a sharing policy, broadcasting playout synchronization, sharing a list of content items being consumed by hosting user's to the remote user for the remote user to determine interest and device whether to join into the watch party, using front-facing or inward-facing camera of the XR device, capturing live images in its field of view of the XR device, capturing virtual images in the field of view of the XR device, maintaining a table of all displays in the host's environment, determining the current location of the host's XR device and determining its coordinates, measuring translational and/or rotational movements and field of view based on the translational and/or rotational movements, using the gyroscope located in the IMU to measure the angular velocity or the rotation, determining a narrow subset of the field of view, which is the line of sight (LOS) (also referred to as gaze or hosting user or remote user's gaze), tracking movement of the user's eyeballs to determine the LOS, accessing remote user profiles to determine consumption preferences, and performing functions related to all other processes and features described herein.

In some embodiments, one or more parts of, or the entirety of system 200, may be configured as a system implementing various features, processes, functionalities and components of FIGS. 1, and 4-18. Although FIG. 2 shows a certain number of components, in various examples, system 200 may include fewer than the illustrated number of components and/or multiples of one or more of the illustrated number of components.

System 200 is shown to include a computing device 218, a server 202 and a communication network 214. It is understood that while a single instance of a component may be shown and described relative to FIG. 2, additional instances of the component may be employed. For example, server 202 may include, or may be incorporated in, more than one server. Similarly, communication network 214 may include, or may be incorporated in, more than one communication network. Server 202 is shown communicatively coupled to computing device 218 through communication network 214. While not shown in FIG. 2, server 202 may be directly communicatively coupled to computing device 218, for example, in a system absent or bypassing communication network 214.

Communication network 214 may comprise one or more network systems, such as, without limitation, an internet, LAN, WIFI or other network systems suitable for processing applications, including watch party applications and platforms or other applications that can be installed on XR devices to establish a watch party. In some embodiments, system 200 excludes server 202, and functionality that would otherwise be implemented by server 202 is instead implemented by other components of system 200, such as one or more components of communication network 214. In still other embodiments, server 202 works in conjunction with one or more components of communication network 214 to implement certain functionality described herein in a distributed or cooperative manner. Similarly, in some embodiments, system 200 excludes computing device 218, and functionality that would otherwise be implemented by computing device 218 is instead implemented by other components of system 200, such as one or more components of communication network 214 or server 202 or a combination. In still other embodiments, computing device 218 works in conjunction with one or more components of communication network 214 or server 202 to implement certain functionality described herein in a distributed or cooperative manner.

Computing device 218 includes control circuitry 228, display 234 and input circuitry 216. Control circuitry 228 in turn includes transceiver circuitry 262, storage 238 and processing circuitry 240. In some embodiments, computing device 218 or control circuitry 228 may be configured as electronic device 300 of FIG. 3.

Server 202 includes control circuitry 220 and storage 224. Each of storages 224 and 238 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each storage 224, 238 may be used to store host or remote user profiles and preferences, such as preferences related to restrictions, preferences, and customizations of the host and the remote users in sharing and receiving a digital twin, list of displays in the spatially mapped room, spatial mapping of the host's environment, spatial coordinates and anchors for all the displays within the spatially mapped room, subscription status of remote users with service providers, and AI and ML algorithms. Non-volatile memory may also be used (e.g., to launch a boot-up routine and other instructions). Cloud-based storage may be used to supplement storages 224, 238 or instead of storages 224, 238. In some embodiments, data relating to host or remote user profiles and preferences, such as preferences related to restrictions, preferences, and customizations of the host and the remote users in sharing and receiving a digital twin, list of displays in the spatially mapped room, spatial mapping of the host's environment, spatial coordinates and anchors for all the displays within the spatially mapped room, subscription status of remote users with service providers, and AI and ML algorithms, and data relating to all other processes and features described herein, may be recorded and stored in one or more of storages 212, 238.

In some embodiments, control circuitry 220 and/or 228 executes instructions for an application stored in memory (e.g., storage 224 and/or storage 238). Specifically, control circuitry 220 and/or 228 may be instructed by the application to perform the functions discussed herein. For example, the control circuitry 220 and/or 228 may be instructed by the application to enable a watch party, generate a spatial map of the host's environment, generate a digital twin that includes the spatial map and displays within the spatially mapped room. In some implementations, any action performed by control circuitry 220 and/or 228 may be based on instructions received from the application. For example, the application may be implemented as software or a set of executable instructions that may be stored in storage 224 and/or 238 and executed by control circuitry 220 and/or 228. In some embodiments, the application may be a client/server application where only a client application resides on computing device 218, and a server application resides on server 202.

The application may be implemented using any suitable architecture. For example, it may be a stand-alone application wholly implemented on computing device 218. In such an approach, instructions for the application are stored locally (e.g., in storage 238), and data for use by the application is downloaded on a periodic basis (e.g., from an out-of-band feed, from an internet resource, or using another suitable approach). Control circuitry 228 may retrieve instructions for the application from storage 238 and process the instructions to perform the functionality described herein. Based on the processed instructions, control circuitry 228 may determine a type of action to perform in response to input received from input circuitry 216 or from communication network 214. For example, in response to determining that a majority of remote user's gaze is directed at a first display and not a second or third display, the control circuitry 228 may alter the remote users not looking at the first display to direct their attention to the first display.

In client/server-based embodiments, control circuitry 228 may include communication circuitry suitable for communicating with an application server (e.g., server 202) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 214). In another example of a client/server-based application, control circuitry 228 runs a web browser that interprets web pages provided by a remote server (e.g., server 202). For example, the remote server may store the instructions for the application in a storage device. The remote server may process the stored instructions using circuitry (e.g., control circuitry 228) and/or generate displays. Computing device 218 may receive the displays generated by the remote server and may display the content of the displays locally via display 234 or on a remote user's XR device. This way, the processing of the instructions is performed remotely (e.g., by server 202) while the resulting displays, such as the display windows described elsewhere herein, are provided locally on computing device 218. Computing device 218 may receive inputs from the user via input circuitry 216 and transmit those inputs to the remote server for processing and generating the corresponding displays. Alternatively, computing device 218 may receive inputs from the user via input circuitry 216 and process and display the received inputs locally, by control circuitry 228 and display 234, respectively.

Server 202 and computing device 218 may transmit and receive content and data such host or remote user profiles and preferences, such as preferences related to restrictions, preferences, and customizations of the host and the remote users in sharing and receiving a digital twin, list of displays in the FOV of all users, list of displays in the spatially mapped room, spatial mapping of the host's environment, spatial coordinates and anchors for all the displays within the spatially mapped room, metadata associated with content displayed in the displays in the host's environment, zones within the spatial map, genre's associated with each zone in the spatial map, subscription status of remote users with service providers, and AI and ML algorithms. Control circuitry 220, 228 may send and receive commands, requests, and other suitable data through communication network 214 using transceiver circuitry 260, 262, respectively. Control circuitry 220, 228 may communicate directly with each other using transceiver circuits 260, 262, respectively, avoiding communication network 214.

It is understood that computing device 218 is not limited to the embodiments and methods shown and described herein. In nonlimiting examples, computing device 218 may be a primary device, a personal computer (PC), a laptop computer, a tablet computer, a WebTV box, a personal computer television (PC/TV), a PC media server, a PC media center, a handheld computer, a mobile telephone, a smartphone, a virtual, augment, or mixed reality device, or a device that can perform function in the metaverse, or any other device, computing equipment, or wireless device, and/or combination of the same capable of suitably displaying virtual reality displays or viewing augmented reality via the XR device.

Control circuitry 220 and/or 218 may be based on any suitable processing circuitry such as processing circuitry 226 and/or 240, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core 19 processor). In some embodiments, control circuitry 220 and/or control circuitry 218 are configured to implement a process for generating a watch party between a plurality of XR devices, inviting a plurality of remote users to join the generated watch party, joining the XR devices into a watch party that is hosted by a host XR device after receiving an acceptance from the remote users to join the watch party, generate a spatial map of the hosting user's environment, which may be the room in which the hosting user is located when the watch party is established, identifying all displays in the room (e.g., both physical and virtual displays), where the physical displays may be located in any part of the room and the virtual displays that may be within the spatially mapped room, identifying all objects and other items in the room, identifying all virtual objects that may be within the spatially mapped room, identifying coordinates and dimensions of each display, spatially anchoring the displays, such as to an arbitrary origin or to an object in the room, generating a digital twin of the displays and the host's environment leveraging the spatially mapped room, determining sharing and receiving restrictions, preferences, and other criteria, sharing metadata associated with content displayed on a display in the host's environment with the remote user subject to the sharing and receiving restrictions, preferences, and other criteria, customizing the digital twin for each remote user based on the remote user's receiving restrictions, preferences, and other criteria, displaying a clip or a still image of the content item displayed on the display in the host's environment on the remote user's XR device, determining whether the remote user has subscription with a content provider that allows the remote user to access a content item shared in the digital twin, providing subscription offers to the remote user, determining the remote user's bandwidth constraints in receiving and displaying all or portion of the digital twin, all or some of the displays from the hosting user's environment that are shared as part of the digital twin, generating zones in the spatially mapped room, sharing some of the zone based on the determined bandwidth restrictions of the remote user, preloading content on the remote user's XR device, generating avatars associated with the remote users to be displayed on the host's XR device, tracking gaze of users associated with remote XR devices that are joined into the watch party, determining consumption progress and focus of gaze of the remote users, alerting remote users of consumption by some or a majority of other remote users in the watch party, suggesting sharing content to the hosting user, generating texturized point cloud, generating spatial tags, determining a sharing policy, broadcasting playout synchronization, sharing a list of content items being consumed by hosting user's to the remote user for the remote user to determine interest and device whether to join into the watch party, using front-facing or inward-facing camera of the XR device, capturing live images in its field of view of the XR device, capturing virtual images in the field of view of the XR device, maintaining a table of all displays in the host's environment, determining the current location of the host's XR device and determining its coordinates, measuring translational and/or rotational movements and field of view based on the translational and/or rotational movements, using the gyroscope located in the IMU to measure the angular velocity or the rotation, determining a narrow subset of the field of view, which is the line of sight (LOS) (also referred to as gaze or hosting user or remote user's gaze), tracking movement of the user's eyeballs to determine the LOS, accessing remote user profiles to determine consumption preferences, and performing functions related to all other processes and features described herein.

Computing device 218 receives a user input 204 at input circuitry 216. For example, computing device 218 may receive a user input like the hosting user's selection of content items or change in content items on a display that is located in the host's spatially mapped room.

Transmission of user input 204 to computing device 218 may be accomplished using a wired connection, such as an audio cable, USB cable, ethernet cable or the like attached to a corresponding input port at a local device, or may be accomplished using a wireless connection, such as Bluetooth, WIFI, WiMAX, GSM, UTMS, CDMA, TDMA, 3G, 4G, 4G LTE, or any other suitable wireless transmission protocol. Input circuitry 216 may comprise a physical input port such as a 3.5 mm audio jack, RCA audio jack, USB port, ethernet port, or any other suitable connection for receiving audio over a wired connection or may comprise a wireless receiver configured to receive data via Bluetooth, WIFI, WiMAX, GSM, UTMS, CDMA, TDMA, 3G, 4G, 4G LTE, or other wireless transmission protocols.

Processing circuitry 240 may receive input 204 from input circuit 216. Processing circuitry 240 may convert or translate the received user input 204 that may be in the form of voice input into a microphone, movement or gestures to digital signals, or translational or orientational movement of the extended reality headset. In some embodiments, input circuit 216 performs the translation to digital signals. In some embodiments, processing circuitry 240 (or processing circuitry 226, as the case may be) carries out disclosed processes and methods. For example, processing circuitry 240 or processing circuitry 226 may perform processes as described in FIGS. 1, 5-6, 9, 11, and 14-15B, respectively.

FIG. 3 is a block diagram of an XR device, in accordance with some embodiments of the disclosure. In an embodiment, the XR device 300, is the same equipment device 202 of FIG. 2. The XR device 300 may receive content and data via input/output (I/O) path 302. The I/O path 302 may provide audio content. The control circuitry 304 may be used to send and receive commands, requests, and other suitable data using the I/O path 302. The I/O path 302 may connect the control circuitry 304 (and specifically the processing circuitry 306) to one or more communications paths. I/O functions may be provided by one or more of these communications paths but are shown as a single path in FIG. 3 to avoid overcomplicating the drawing.

The control circuitry 304 may be based on any suitable processing circuitry such as the processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

In client-server-based embodiments, the control circuitry 304 may include communications circuitry suitable for allowing communications between two separate user devices, such as the host's XR device and the remote user's XR device to share a digital twin of the host's environment with the remote XR device. Communications circuitry may be used to perform functions related to all other processes and features described herein, including those described and shown in connection with FIGS. 1, and 4-18.

The instructions for carrying out the above-mentioned functionality may be stored on one or more servers. Communications circuitry may include a cable modem, an integrated service digital network (ISDN) modem, a digital subscriber line (DSL) modem, in the cloud, a telephone modem, ethernet card, or a wireless modem for communications with other equipment, or any other suitable communications circuitry. Such communications may involve the internet or any other suitable communications networks or paths. In addition, communications circuitry may include circuitry that enables peer-to-peer communication between XR devices, such as between a host XR device and a remote user XR device or between two remote user XR devices.

Memory may be an electronic storage device provided as the storage 308 that is part of the control circuitry 304. As referred to herein, the phrase “XR device,” “electronic storage device,” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid-state devices, quantum-storage devices, gaming consoles, gaming media, or any other suitable fixed or removable storage devices, and/or any combination of the same. The storage 308 may be used to store host or remote user profiles and preferences, such as preferences related to restrictions, preferences, and customizations of the host and the remote users in sharing and receiving a digital twin, list of displays in the spatially mapped room, spatial mapping of the host's environment, spatial coordinates and anchors for all the displays within the spatially mapped room, subscription status of remote users with service providers, and AI and ML algorithms, and data relating to all other processes and features described herein. Cloud-based storage, described in relation to FIG. 3, may be used to supplement the storage 308 or instead of the storage 308.

The control circuitry 304 may include audio generating circuitry and tuning circuitry, such as one or more analog tuners, audio generation circuitry, filters or any other suitable tuning or audio circuits or combinations of such circuits. The control circuitry 304 may also include scaler circuitry for upconverting and down converting content into the preferred output format of the XR device 300. The control circuitry 304 may also include digital-to-analog converter circuitry and analog-to-digital converter circuitry for converting between digital and analog signals. The tuning and encoding circuitry may be used by the electronic device 300 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 308 is provided as a separate device from the XR device 300, the tuning and encoding circuitry (including multiple tuners) may be associated with the storage 308.

The user may utter instructions to the control circuitry 304, which are received by the microphone 316. The microphone 316 may be any microphone (or microphones) capable of detecting human speech. The microphone 316 is connected to the processing circuitry 306 to transmit detected voice commands and other speech thereto for processing. In some embodiments, voice assistants (e.g., Siri, Alexa, Google Home and similar such voice assistants) receive and process the voice commands and other speech.

The XR device 300 may include an interface 310. The interface 310 may be any suitable user interface, such as a remote control, mouse, trackball, keypad, keyboard, touch screen, touchpad, stylus input, joystick, or other user input interfaces. A display 312 may be provided as a stand-alone device or integrated with other elements of the electronic device 300. For example, the display 312 may be a touchscreen or touch-sensitive display or it may be the screen of the XR device. In such circumstances, the interface 310 may be integrated with or combined with the microphone 316. When the interface 310 is configured with a screen, such a screen may be one or more monitors, a television, a liquid crystal display (LCD) for a mobile device, active-matrix display, cathode-ray tube display, light-emitting diode display, organic light-emitting diode display, quantum-dot display, or any other suitable equipment for displaying visual images. In some embodiments, the display 312 may be a 3D display. The speaker (or speakers) 314 may be provided as integrated with other elements of electronic device 300 or may be a stand-alone unit. In some embodiments, the display 312 may be outputted through speaker 314.

The XR device 300 of FIG. 3 can be implemented in system 200 of FIG. 2 as primary equipment device 202, but any other type of user equipment suitable for allowing communications between two separate user devices for performing the functions related to implementing machine learning (ML) and artificial intelligence (AI) algorithms, and all the functionalities discussed associated with the figures mentioned in this application.

The XR device 300 of any other type of suitable user equipment suitable may also be used to implement ML and AI algorithms, and related functions and processes as described herein. For example, primary equipment devices such as television equipment, computer equipment, wireless user communication devices, or similar such devices may be used. Electronic devices may be part of a network of devices. Various network configurations of devices may be implemented and are discussed in more detail below.

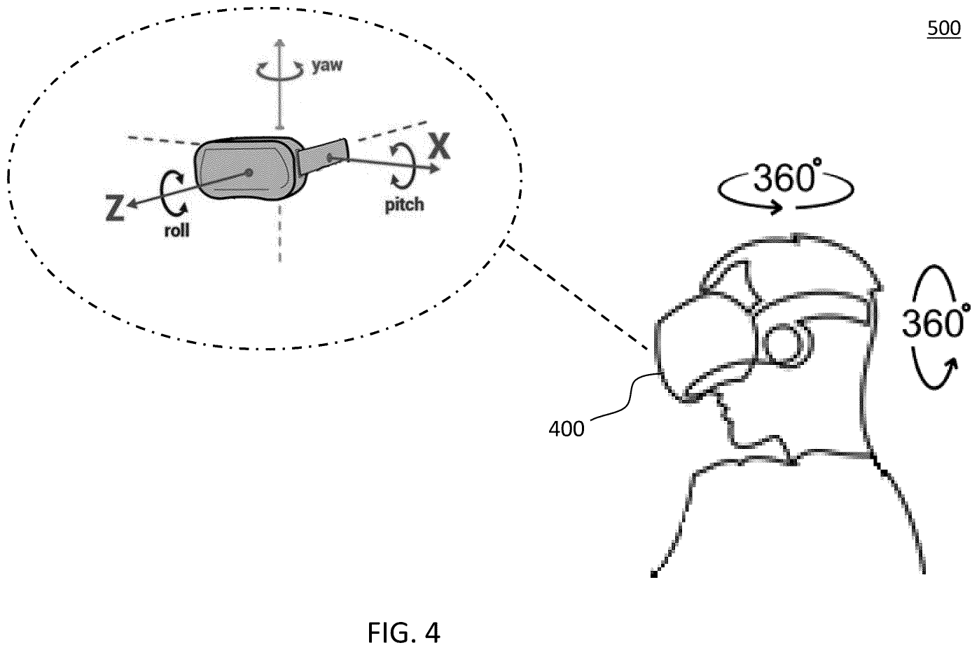

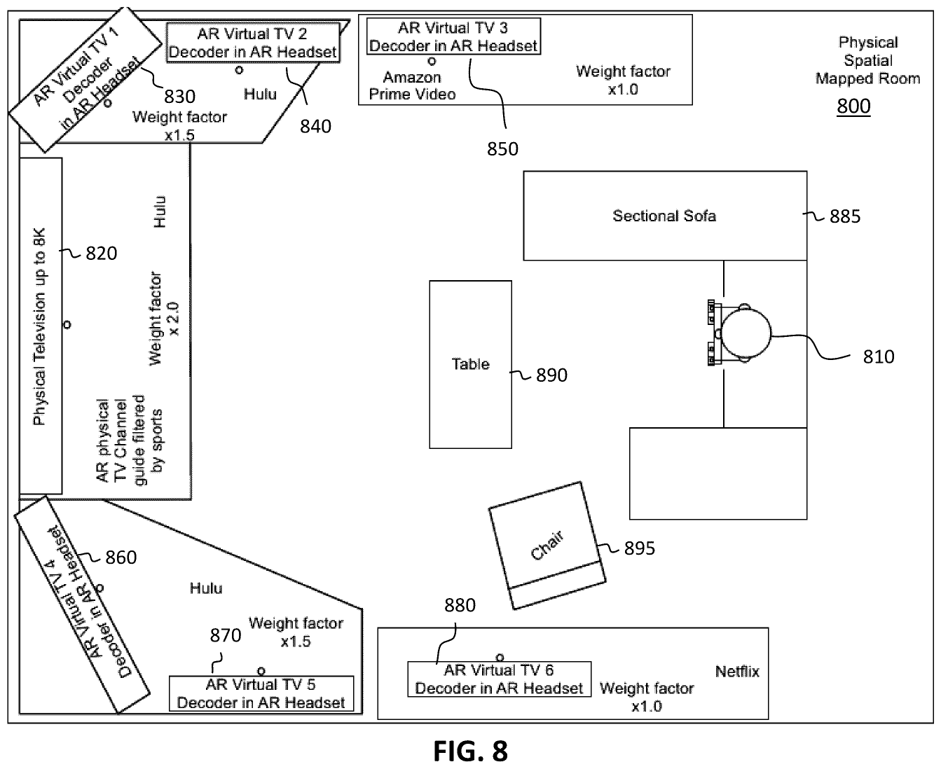

FIG. 4 is an example of an XR device 400 used by the host and remote users, in accordance with some embodiments of the disclosure. In some embodiments, the XR device is a wearable device, such as a headset, and in other embodiments, the XR device may be extended reality glasses, a mobile phone, or a device with a display and a pass-through camera capability. The FOV from the XR device may be used, in some embodiments, to generate a spatially mapped room, such as the room in FIG. 8, using the process of FIG. 9. The XR devices used by the host may be used to create and/or display a digital twin. The shared digital twin may include all displays and content and be shared with the remote user subject to restrictions and preferences.

In some embodiments, the XR device 400 may include a complete system with a processor and components needed to provide the full extended reality experience. In other embodiments, the XR device may rely on external devices to perform the processing, e.g., devices such as smartphones, computers, and servers. For example, the XR device 400 may be an XR headset with a plastic, metal, or cardboard holding case that allows viewing, and it may be connected via a wire, wirelessly or via an application programming interface (API) to a smartphone and use its screen as lenses for viewing.

In one embodiment, the XR device 400 used by the host of the watch party has six degrees of freedom (6DOF). Since the headset works by immersing the user into a virtual environment that has all directions, for a full immersive experience, the user's entire vision, including their peripheral vision, is utilized. As such, an XR device that provides the full 6DOF may be used (although an XR device with 3DOF can also be used).

Having the 6DOF allows the host of the watch party to move in all directions and also view all physical displays and objects as any augmented reality displays and any virtual objects in the spatially mapped room. These 6DOF correspond to rotational movement around the x, y, and z axes, commonly termed pitch, yaw, and roll, as well as translational movement along those axes, which is like moving laterally along any one direction x, y, or z.

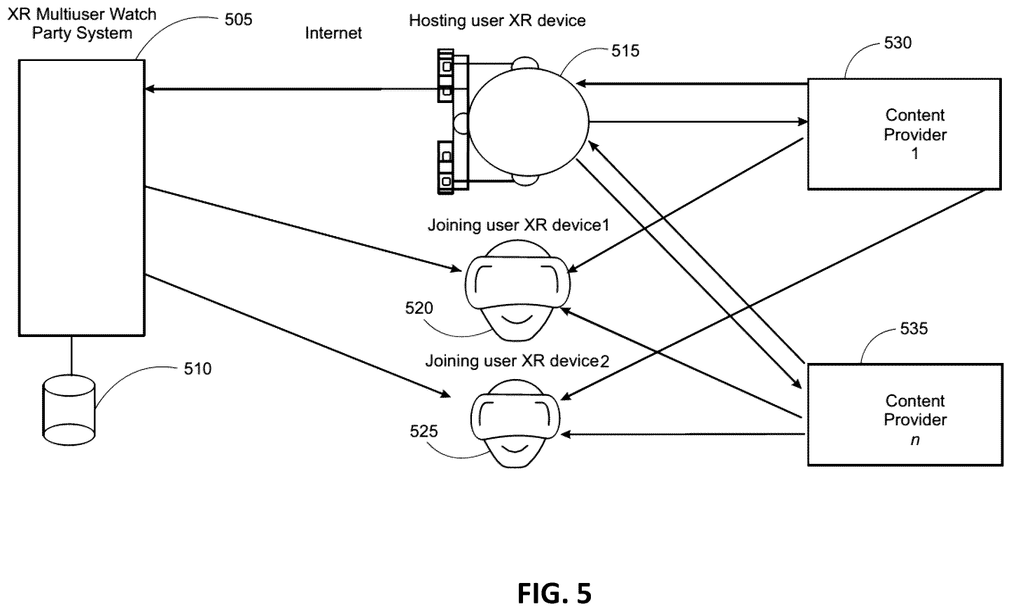

Tracking all 6DOF allows the control circuitry to capture the host's FOV and the narrower section of the FOV, i.e., the line of sight (LOS) or the host's gaze. Having the current and real-time update of the FOV and the host's gaze allows the control circuitry to determine which display is currently in the FOV of the host such that metadata from that display may be shared with the remote users in the watch party. The remote user(s) may also use a similar XR device, as depicted in FIG. 5, to consume the digital twin shared by the host as part of the watch party. Although some references have been made to the type of XR device, the embodiments are not so limited, and any other XR device available in the market may also be used with the embodiments described herein.

FIG. 5 is an example of architecture used in a multiple display watch party, in accordance with some embodiments of the disclosure. In some embodiments, the architecture used in the multiple display watch party may include an XR device associated with the hosting user, a multiuser watch party system, a database communicatively connected to the multiuser watch party system, and a plurality of remote user XR devices also communicatively connected to the multiuser watch party system.

In some embodiments, the XR device of the hosting user may send a compressed texturized point cloud with the hosting user's user account ID and room ID to the multiuser watch party system. The XR device of the hosting user may also send spatial coordinates for all zones that are defined in the spatial layout to the system or server associated with the watch party, such as the system depicted in FIG. 2. The XR device of the hosting user may further send zone policies along with zone IDS, account IDS, and user IDS associated with the zone policies to the multiuser watch system. The account ID and user ID sent may be associated with the hosting user. The XR device of the hosting user may also send a physical display's as well as virtual display's spatial definition coordinates along with their spatial tag coordinates for the hosting user's account, along with the room ID and zone ID associated with the physical display as well as virtual display. The room ID may be the unique name given to the room in which the hosting user is hosting the virtual party, a replica of which is to be shared with the remote user(s).

The multiuser watch system, upon receiving the above-mentioned data from the hosting user's XR device, may then save the data to a database and also transmit it to all the remote XR devices associated with the remote users that have joined the watch party, such as remote users 1, 3, 4 and 7 in FIG. 1 and remote users R1, R2 and R3 in FIG. 18.

The XR device associated with the hosting user may also get a content stream and a content stream timing synchronization from multiple content providers, such as content provider 1 530 and content provider n 535 in FIG. 5. The XR device may play or pause the content received from the content stream and, based on the XR device's play/pause function, the XR device may provide the content stream timing synchronization to the content provider. The content provider may obtain such content stream timing synchronization and synchronize the content stream provided to the remote user such that the remote user and hosting user's timing of the content stream may be synchronized.

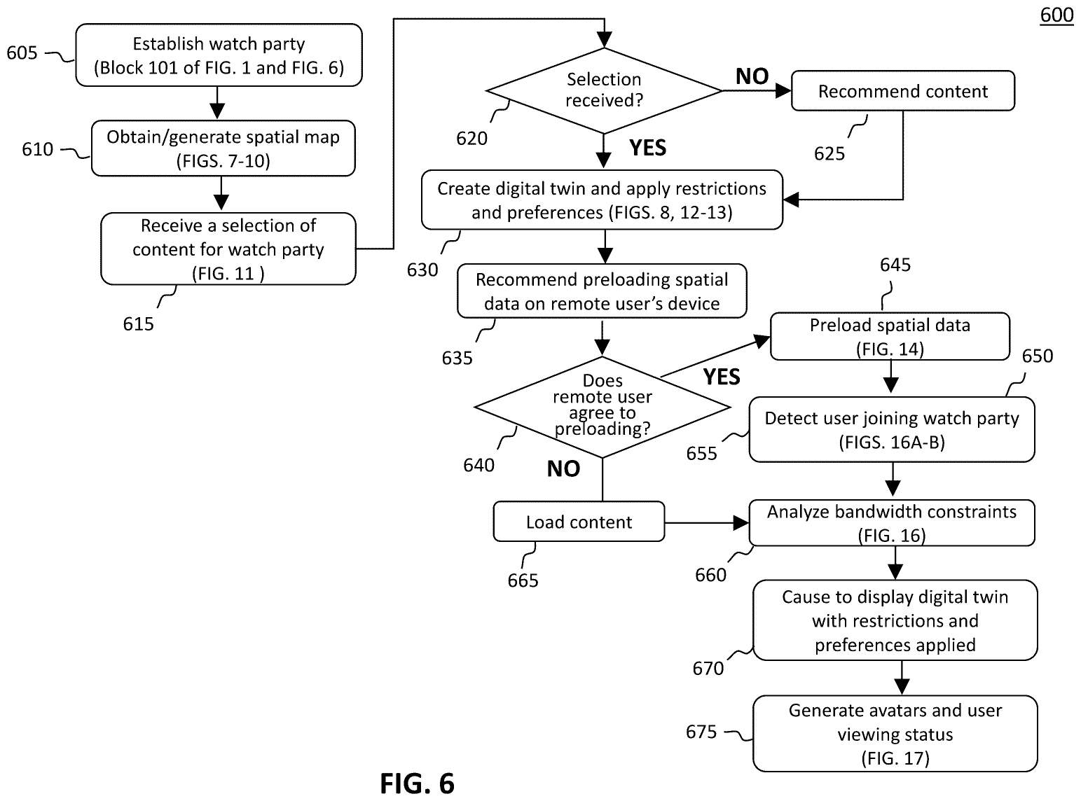

FIG. 6 is flowchart of a process 600 for establishing a watch party and sharing content being consumed by a host, and the host's spatial environment, with remote XR devices in the watch party, in accordance with some embodiments of the disclosure.

The process 600 may be implemented, in whole or in part, by systems or devices such as those shown in FIG. 2-3. One or more actions of the process 600 may be incorporated into or combined with one or more actions of any other process or embodiments described herein. The process 600 may be saved to a memory or storage (e.g., any one of those depicted in FIGS. 2-3) as one or more instructions or routines that may be executed by a corresponding device or system to implement the process 600.

In some embodiments, at block 605, a watch party may be established the hosting user wearing or using the XR device, such as the device in FIG. 5, may select one or more options in their extended reality headset to initiate the process of establishing the watch party. The hosting user may select one or more contacts from their address book, such as an address book stored in the XR device or on any device associated with the XR device, such as the host's phone. The hosting user may also gesture to auto-initiate the process of establishing a watch party and inviting remote users.

Once contacts are selected, the host XR device may send a request to intended remote XR devices to join the watch party. In some embodiments, a setting from a previous watch party may be saved and the same setting may be used to send an invitation for a current watch party. A watch party application or platform may also leverage machine learning or artificial intelligence data to automatically suggest or invite remote users to the current watch party. Some details of the watch party are also described in relation to the description of block 101 in FIG. 1.

At block 610, in some embodiments, a spatial map of the room or area in which the host is currently located during the watch party is obtained. If it is not available, then it is generated. The spatial map may be created by a variety of means, including using an extended reality headset worn by the host. For example, the system may prompt the host wearing the extended reality headset to orient in a plurality of directions. The system may guide the host wearing the extended reality headset by displaying an arrow or another symbol on a screen of the extended reality headset to show the direction to orient. Based on the orientation, the system may capture, via the camera of the extended reality headset, all the objects and layout of the room to create a spatial map.

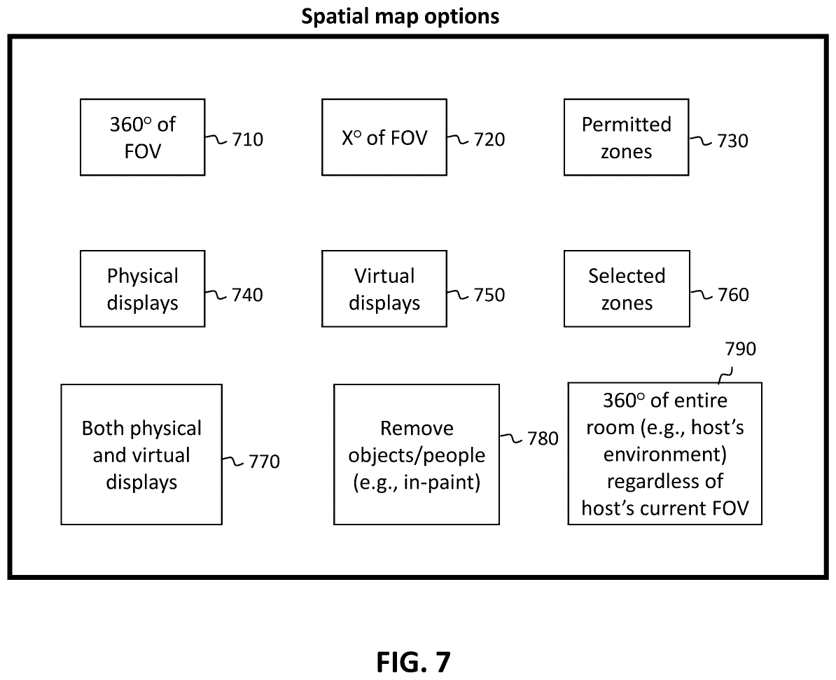

The spatial map generated may include a plurality of spatial anchors for the physical and virtual displays in their spatially mapped room. The spatial map may be a texturized 3D mesh or point cloud representation of hosting user's room. The spatial map may include all coordinates of the room in which the host is consuming content. It may also include coordinates of each object, display, person, or any item or structure within the room. The spatial map may also include zones that subdivide the room into a plurality of zones. Further details relating to the spatially mapped room and generating of the spatially mapped room are described in relation to FIGS. 7-10.

The spatially mapped room is used to generate a replica of the host's environment, including all displays (physical and virtual) with the exact sizes and dimensions of the physical and virtual displays in the hosting user's spatially mapped room. Such spatial mapping may be used to host multiuser watch parties where remote users have the ability to watch multiple live or VOD shows together with host (i.e., while still being remote) in an extended reality environment. In other words, whatever the host is watching, or whatever is in the spatially mapped room, may be shared with the remote users to provide the feel of sitting together in the same living room, i.e., in the same environment, and consuming the content items on all displays together (after sharing restrictions and preferences are applied).

At block 615, in some embodiments, the host may select which content to use for the watch party. In some embodiments, the system, such as system 200 of FIG. 2, or the watch party app/platform, may suggest content at block 625, if a determination is made at block 620 that the selection has not been received (i.e., the host has not selected the content). This is the content that is displayed on physical and/or virtual displays in the spatially mapped room. Since there may be multiple displays involved, i.e., multiple displays within the spatially mapped room, multiple content items from multiple content sources may be involved in the watch party.

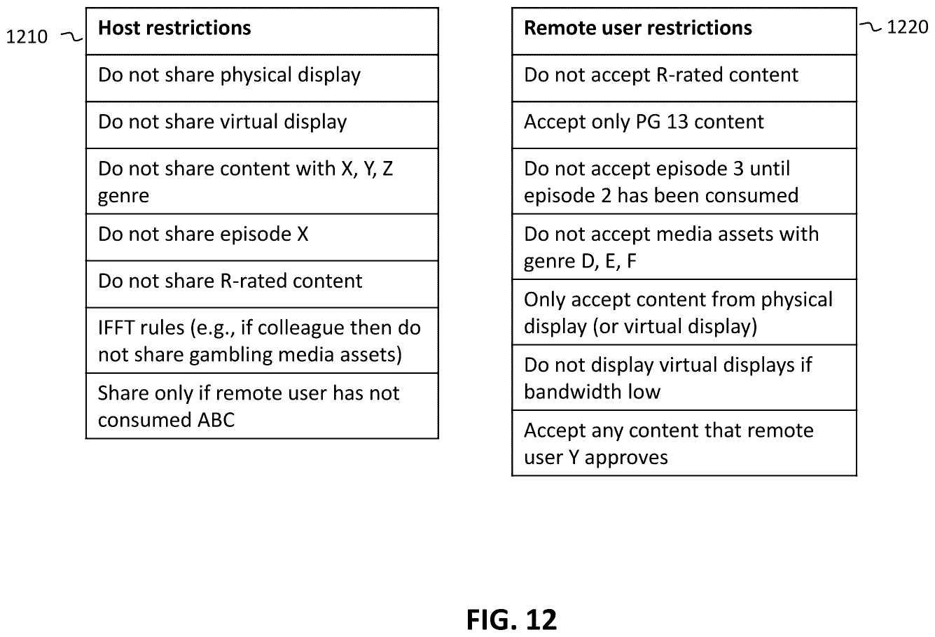

Once the content is received, at block 630, a digital twin may be generated. The digital twin generated may be different for each remote user based on their consumption restrictions, preferences, and recommendations. In other embodiments, the digital twin created may be the same; however, further processing of the digital twin may be performed to customize it for different remote users based on their consumption restrictions, preferences, and recommendations. Some examples of consumption restrictions, preferences, and recommendations are described in relation to block 104A and FIGS. 12-13.

At block 635, a recommendation may be made to preload spatial data, e.g., the spatially mapped room, on the remote user's XR device. In other embodiments, the spatial data may be loaded on a server, or some other storage associated with the remote user's XR device and accessed by the XR device at the time of rendering.

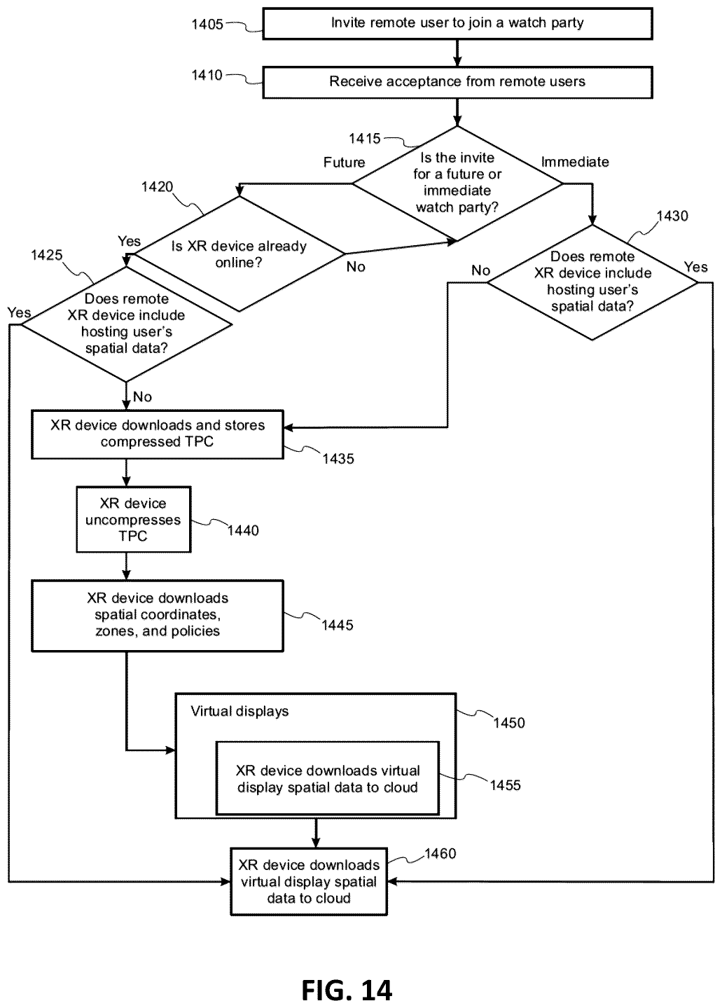

At block 640, a determination may be made whether the remote user agrees to the preloading of the spatial data. If a determination is made, at block 640, that the remote user does agree, then, at block 645, the spatial data may be preloaded onto the remote user's XR device. In another embodiment, instead of giving the user an option to agree to the preloading, the application, the watch party platform, or the system, such as the system in FIG. 2, may automatically preload the remote user's XR device with the spatial data and provide them the option to delete it. Further information relating to preloading of spatial data is described in relation to FIG. 14. In the event that the remote user disagrees to preloading of the content, then the process may proceed from block 640 to 665, where the content may be loaded after the user joins the watch party and then to block 660, where bandwidth constraints are analyzed.

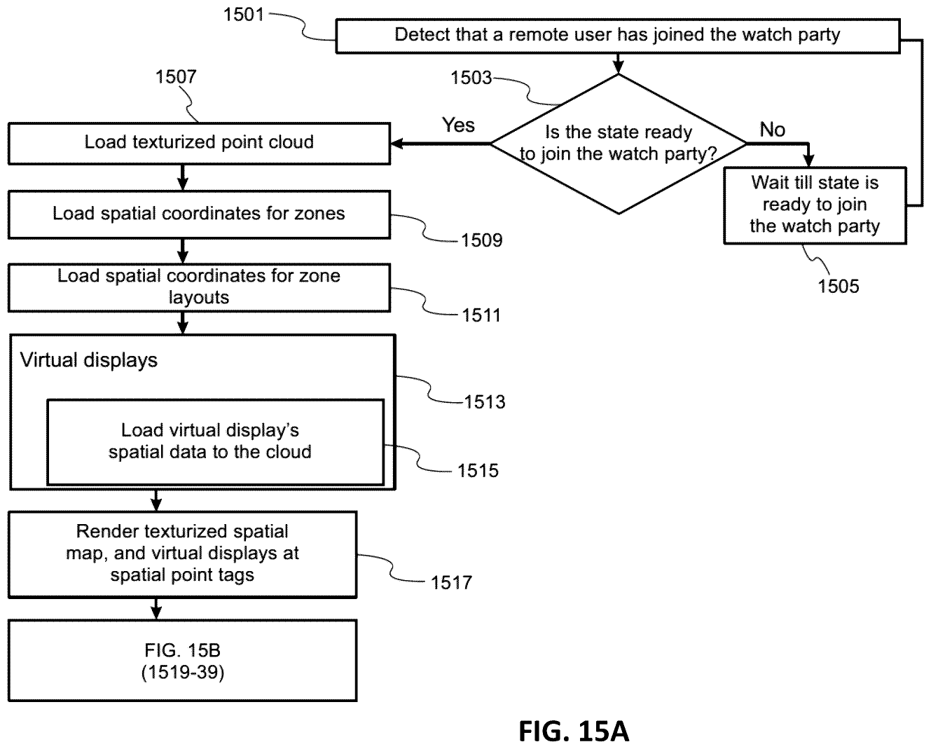

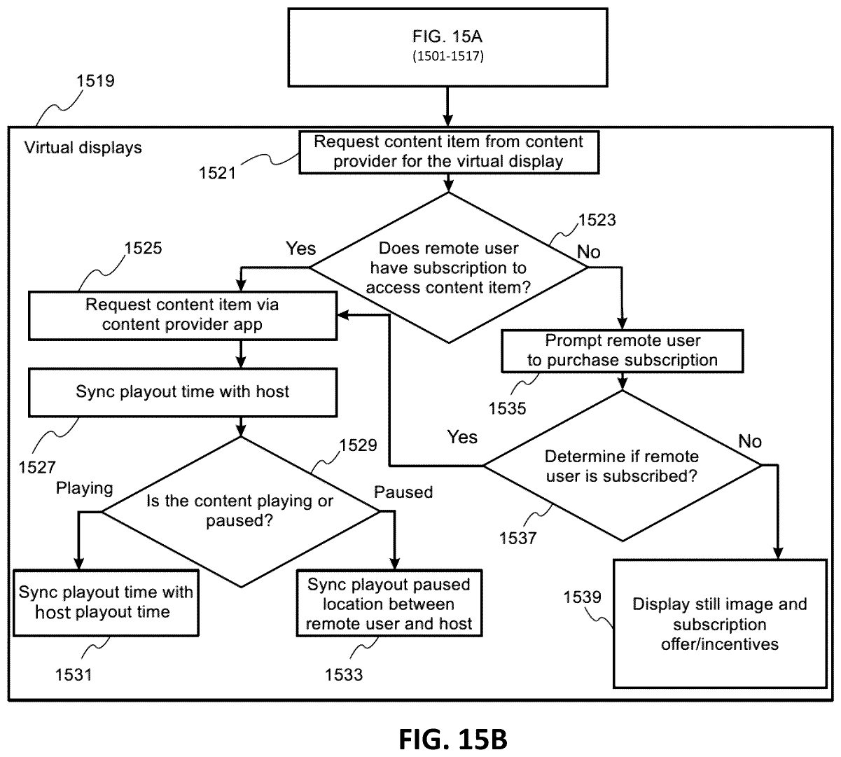

At block 655, a detection may be made that the remote user has joined the watch party. Once the user has joined the watch party, a process may be executed to use the spatial data to render the hosting user's environment, as well as content items displayed in the displays within the spatially mapped room, on the remote user's XR device. The process is described below in relation to FIGS. 15A-B.

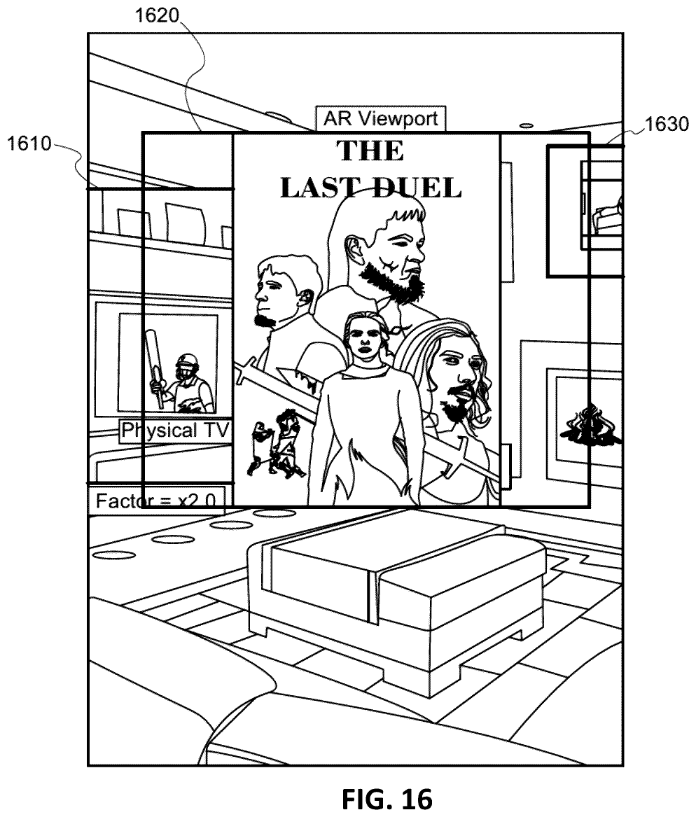

At block 660, in some embodiments, the system using control circuitry, such as the system in FIG. 2, may determine bandwidth constraints and accordingly adjust the rendering of the digital twin on the remote user's XR device. For example, as depicted in FIG. 16, instead of displaying a clip of the content being consumed by the hosting user, a still image of that content item may be displayed, due to bandwidth constraints.

At block 670, in some embodiments, the system may cause to display the digital twin, with the restrictions and preferences applied, on the remote user's XR device.

At block 675, avatars may be generated and displayed on the hosting user's XR device. For example, if remote user R1 of FIG. 18 is currently consuming a first display (TV1), from the plurality of displays shared in a watch party, then an avatar of remote user R1 may be displayed on or next to first display in the host's XR device. The system may monitor the gaze of each remote user to determine which screen is currently being consumed and use that data to generate the avatars on the XR device associated with the hosting user. An example of various remote users consuming different displays from the watch party is depicted in FIG. 18.

FIG. 7 is a block diagram of an example of spatial mapping options, in accordance with some embodiments of the disclosure. In some embodiments, as depicted at block 710, the spatial map/layout may include a 360° view of the room where the host XR device is located. To generate such a spatial map, the control circuitry 220 and/or 228 of system 200 may guide the hosting user to make a full 360° rotation about the room such that the entire room can be captured via the camera of the XR device.

In another embodiment, as depicted at block 720, a spatial map may be created for a portion of the room, such as 120°, 180°, or any other desired portion from the FOV of the host XR device.

In another embodiment, as depicted at block 730, a spatial map may be created for only permitted zones. In yet another embodiment, the spatial map may be created for the entire 360°, and various zones may be marked within the created spatial map. A decision may be made later as to which zones from the spatial map may be designated as permitted zones for sharing with the remote user. For example, if a hosting user's environment includes an area that the hosting user does not want to share, then such zone may be marked as a restricted zone and not be shared with all the permitted zones.

In another embodiment, although a spatial map may be generated for the entire room where the hosting user is located, only physical displays 740, virtual displays 750, selected zones 760, or both physical and virtual displays 770 may be shared with the remote user. In yet another embodiment, certain objects or people may be in-painted and removed such that when the spatial map is shared such objects and people are not shared with the remote user. For example, if the hosting user has another friend in the same room while they're hosting the watch party, the hosting user may request not to share in the digital twin, the person in the room. Accordingly, the control circuitry 220 and/or 228 of system 200 in FIG. 2 may perform in-painting to remove the person that is not to be shared and replace them with a background, as depicted at 780. Likewise, the hosting user may identify individual objects or zones that are not to be displayed, and the system may accordingly perform in-painting or apply other camouflaging or object removal techniques to remove such objects or zones from the shared digital twin.

In yet another embodiment, at 790, spatial map may be generated for the entire room where the hosting user is located irrespective and regardless of what is currently in the FOV of the host's XR device. As such, even of the host is looking elsewhere in the room while in the watch party, or has temporarily left the room, all of the entire room may be made available to the remote user's XR device.

FIG. 8 is an example of a spatially mapped room with objects and displays, in accordance with some embodiments of the disclosure. Ask depicted, a hosting user 810 is sitting in the spatially mapped room 800 wearing an XR device and facing towards the physical television 820. The room in which the hosting user 810 is located during the watch party also includes a plurality of virtual displays 830-880. The room also includes a plurality of objects, such as sectional sofa 885, table 890, and chair 895. When the room is spatially mapped, depending on the spatial mapping options described in FIG. 7, some or all of the environment of the hosting user 810 is captured. An exact replica of the spatially mapped room including all physical 820 and AR 830-880 displays along with all objects in the room 885-895 and any virtual objects displayed in the XR device hosting user's XR device are captured. In addition, exact spatial coordinates of each display and object are determined such that a replica layout can be generated and rendered in the remote user's XR device.

FIG. 9 is flowchart of a process 900 for generating a spatially mapped room, in accordance with some embodiments of the disclosure. The process 900 may be implemented, in whole or in part, by systems or devices such as those shown in FIG. 2-3. One or more actions of the process 900 may be incorporated into or combined with one or more actions of any other process or embodiments described herein. The process 900 may be saved to a memory or storage (e.g., any one of those depicted in FIGS. 2-3) as one or more instructions or routines that may be executed by a corresponding device or system to implement the process 900.

In some embodiments, process 900 is used for creating the spatial map of the room. This process includes defining the spatial map coordinates for all defined zones along with all the spatial layout coordinates and policies associated with the defined zones. The spatial map is converted into a standardized point cloud format, compressed, and uploaded and saved to the user's account as a user's room with a unique name assigned to the room. It includes creating an exact virtual representation including the dimensions of the physical TVs/displays along with their exact spatial tag locations within the spatially mapped room. All AR virtual TV's exact spatial coordinate dimensions and spatial tag locations are created and saved for the room. More specifically, the process is described below in steps from blocks 905-986.

In some embodiments, at block 905, a 3D spatial map mesh or a point is created. In this embodiment, the XR device creates the 3D spatial map mesh or point with texture overlay of the hosting user's room or other space where the hosting user is hosting the watch party. The XR device does so by leveraging its own onboard RGB, cameras, inertial measurement unit (IMU) and depth sensors.

At block 910, in one embodiment, physical displays may be identified and spatial anchors for the identified physical displays may be created. In this embodiment, the XR device may perform the function of identifying physical displays and then spatially anchoring them. This process of identifying physical displays, in one embodiment, may involve the XR device obtaining images captured by its own camera. The images may then be analyzed to determine if they are images of physical displays. Techniques such as image recognition analysis of the obtained images, analysis of image using AI, or image comparison with other images of TVs may be used to determine whether the images can be associated with a physical display. With respect to using AI, the XR device may leverage an AI engine executing an AI algorithm to determine which objects in its FOV are physical displays and, based on the AI recommendation, identify them as such. In another embodiment, the hosting user may identify the physical displays in the room, and the XR device may spatially anchor them. Spatial anchoring for the physical displays may involve anchoring them to an arbitrary origin or to another object that is in the FOV of the XR device.

In some embodiments, physical displays that are in the room where the host has launched the watch party may be identified. To identify all such physical displays, i.e., even those currently out of the FOV, the system may prompt the hosting user wearing the XR device to orient 360° in the room such that the entire room can be captured. Such a mapping may allow the system to capture other physical displays that may come into the hosting user's FOV when the user changes their orientation in the room.

At block 915, in one embodiment, the XR device may be connected to the physical display. The connection may be a wireless connection, such as via Bluetooth or Wi-Fi, that allows the XR device to communicate with the physical display.

At block 920, The XR device may obtain attributes of the physical display. These may include the size, resolution, brand, model, screen size and all other details related to the physical display. Since the digital twin created may be a 3D model, the attributes obtained may be used to generate a 3D digital replica of the physical display that is part of the digital twin. Once created, the look and feel in a remote user's XR device of the physical display would be the same as or similar to the look and feel from the XR device of the hosting user.

At block 925, a plurality of spatial zones may be defined. Each spatial zone may be associated with an area or 3D space of the overall digital map created. Each spatial zone may also be associated with the type of objects in the overall digital map. For example, a spatial zone may be defined to include only physical displays, virtual displays, selected physical objects in the room where the watch party is being hosted. Spatial zones may also be defined based on areas in the room where the watch party is being hosted that are bandwidth intensive, require medium bandwidth, or require low bandwidth to transmit and render at a remote user's XR device. For example, if an area in the room has many objects that are graphic intensive (e.g., displays, digital albums, paintings, colorful objects), such an area may be identified as a bandwidth-heavy zone. In some embodiments, the zones may be selected by the hosting user. In other embodiments, the zones may be automatically selected by the device, or the control circuitry 220 and/or 228 of FIG. 2, without user input. For example, the XR device or control circuitry 220 and/or 228, such as by leveraging an AI analysis of the room, may automatically define zones that include physical displays, virtual displays, selected physical objects in the room where the watch party is being hosted, selected virtual objects within the spatially mapped room, zones based on bandwidth, or zones based on rendering complexity.

At block 930, in some embodiments, spatial zones that include virtual displays may be identified. These may be virtual displays that are visible in the FOV of the XR device. In some embodiments, all virtual displays in the room, even if they are not currently visible in the FOV of the hosting user's XR device but would be made available to the hosting user's XR device if the hosting user were to orient toward them, are identified and mapped in the room. Such a mapping that is outside of the current FOV may allow the system to capture other virtual displays (and virtual objects) that may come into the user's FOV when the user changes their orientation in the room. To identify all such virtual displays, i.e., even those currently out of FOV, the system may prompt the user to orient 360° in the room such that the entire room can be captured.

At block 935, the spatial coordinates for all the zone layouts may be saved. They may be saved on the XR device, on a storage associated with the XR device, a remote storage, or in the cloud.

At block 940, in some embodiments, a virtual display layout policy may be defined. The layout policy may be defined by the hosting user, the XR device, or the control circuitry 220 and/or 228. The layout policy may include all restrictions and preferences of the hosting user. The layout policy may also include rules generated by the XR device, or the control circuitry 220 and/or 228 based on ML and AI engine recommendations, such as implementing policies based on prior consumption behavior of the hosting user. For example, if in the past the hosting user did not share a virtual display with a particular remote user, such prior behavior may be evaluated and, as needed, a policy may be generated accordingly.

At block 945, viewing genre and VOD/transport stream (TS) TV policies may be defined. The layout policy may be defined by the hosting user, the XR device, or the control circuitry 220 and/or 228. The layout policy may include all restrictions and preferences of the hosting user associated with genre and VOD/TS TV. For example, if in the past the hosting user did not share a particular genre with remote users or with specific remote users based on the relation with the hosting user, accordingly a policy may be generated to ensure such user preferences are implemented in the current watch party.

At block 950, virtual displays may be added to create zones. The adding of the virtual displays may be by the user via using their XR device or it may be by the XR device or the control circuitry 220 and/or 228.

At block 955, the room for which the spatial map is being generated may be named with a unique name. The hosting user may select a name, such as Megan's birthday watch party, Superbowl watch party, NBA playoffs watch party, etc. The XR device or the control circuitry 220 and/or 228 may also automatically analyze the scene and generate or suggest a unique name for the spatially mapped room. For example, based on the camera input, and leveraging AI or image recognition, if the XR device or the control circuitry 220 and/or 228 determines that the room is set up for a birthday (e.g., balloons, happy birthday sign, and cake are within the spatially mapped room), it may accordingly automatically name the room as a birthday watch party.

At block 960, the spatial layout created may be uploaded to the cloud. The user may select or approve the choice to upload to the cloud.

At block 965, a determination may be made whether a point cloud of the layout is created. More specifically, a determination may be made whether a standardized texturized point cloud of the uploaded layout is created. As commonly understood, a point cloud is a set of data points in a 3D coordinate system that represents spatial measurement on the object's surface in its entirety. If a determination is made that a standardized texturized point cloud of the uploaded layout is created, then the process may move to block 970, and otherwise it may move to block 980, where the XR device or control circuitry 220 and/or 228 may convert the texturized spatial map to a standardized point cloud.

If a determination is made that a standardized texturized point cloud of the uploaded layout is created, then, at block 970, the standardized texturized point cloud may be compressed and, at block 972, saved to the cloud with the user's account and a room ID.

At block 974, spatial coordinates, zone layout, and policies may be saved and associated with the user's account and a room ID. To do so, different steps may be taken for virtual displays, as depicted at blocks 976-977, and different steps for physical displays, as depicted at blocks 982-986.

For virtual displays, at block 977, the virtual displays and their coordinates with spatial tag coordinates may be saved. They may be identified as associated with the user's account and a room ID when saved.

At block 982, the generated spatial coordinates for the physical display may include the exact dimensions of the physical display. This so that when a replica is generated in the digital twin, the physical display provides the same look and feel to the remote user as it does to the hosting user.

For physical displays, at block 986, their spatial tag coordinates may be saved. They may be identified as associated with the user's account, a zone, and a room ID when saved.

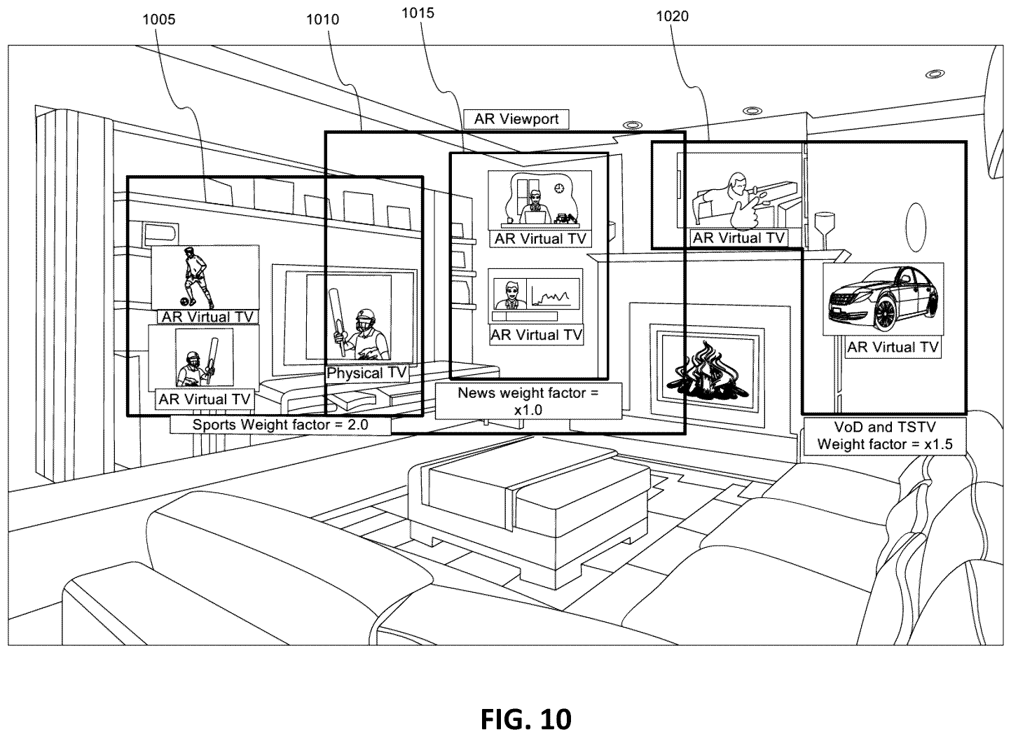

FIG. 10 is an example of zones within a spatially mapped room, in accordance with some embodiments of the disclosure. In this figure, the spatially mapped room may include all physical TVs/displays and virtual TVs/displays grouped in zones. All zones may be mapped out with spatial tag coordinates covering the zones. All physical TVs/displays and virtual TVs/displays may be placed within the zones based on their default layouts. All zones and devices may have their own policies based on QoE, genre, VOD/TSTV pause/resume, layout, etc. As described earlier, the zones may be genre-based, location-based, or based on any other category defined by the hosting user or automatically by the XR device or the control circuitry 220 and/or 228.

In some embodiments, the zones may be weighted based on what is included in the zone. For example, a sports weight factor of 2.0 may be assigned to a zone that has displays showing sports, while a news weight factor of 1.0 may be assigned to a zone that includes news items displayed on the physical/virtual displays. Such zoning may be useful if the hosting user, or the remote user, would like to only share or consume a particular zone associated with a genre, e.g., the remote user wishes to watch only sports and as such may select a zone that is more heavily weighted on sports.

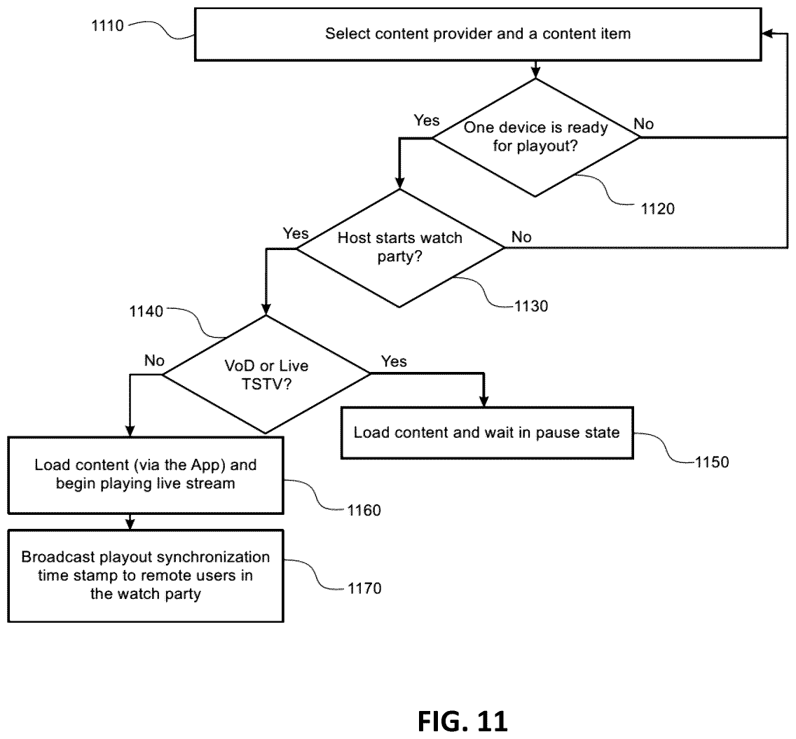

FIG. 11 is flowchart of a process 1100 for selecting content for a multi-user watch party, in accordance with some embodiments of the disclosure. The process 1100 may be implemented, in whole or in part, by systems or devices such as those shown in FIG. 2-3. One or more actions of the process 1100 may be incorporated into or combined with one or more actions of any other process or embodiments described herein. The process 1100 may be saved to a memory or storage (e.g., any one of those depicted in FIGS. 2-3) as one or more instructions or routines that may be executed by a corresponding device or system to implement the process 1100.

In some embodiments, process 1100 is a process for the hosting user hosting the watch party to select content that can come from multiple providers. The process includes, as depicted at block 1110, selecting a content provider and a content item offered by the content provider. For example, the host may select a Netflix™ application and select a movie or an episode offered by Netflix. In this embodiment, the hosting user may select the content provider application, such as via their XR device, and the content item provided by the content provider application may be displayed either on their physical or their virtual display that is within the spatially mapped room.

In some embodiments, at block 1120, a determination may be made if the XR device is ready for playout, in other words, if the host's XR is ready to display the selected content item. If a determination is made that the XR device is ready for the playout, then, at block 1130, it is determined whether the host has started the watch party. If the XR device is not ready for playout, then the process may revert back to block 1110 and be repeated until the XR device is ready for the playout.

In some embodiments, after it is determined, at block 1130, that the host has started the watch party, at block 1140, a determination may be made if the content being shown is a video on demand (VOD) or live TV (TSTV). If a determination is made that the content being displayed is VOD or live TV, then the XR device may load the content and wait in a pause state, as depicted at block 1150. If a determination is made that the content being displayed is not VOD or live TV, then the host's XR device may, at block 1160, load content (via the content provider app) and begin playing the live stream of the content. The host's XR device may also, at block 1170, broadcast a playout synchronization time stamp to remote users in the watch party.

FIG. 12 is a block diagram of examples of host and remote user restrictions for sharing and receiving shared content, in accordance with some embodiments of the disclosure. In some embodiments, the spatial map and the digital twin generated by using the spatial map may be shared with a remote user once the host's sharing restrictions and the remote user's consumption restrictions have been addressed. Some examples restrictions associated with the host's sharing of the digital twin are depicted at block 1210. Additional examples relating to remote user's consumption restrictions are depicted at block 1220. Even though the host may want to share certain content or portions of the digital twin, if the receiving remote user has restrictions in consuming such content, then such portions of the digital twin may not be shared with the remote user (or if shared by the host, then masked or blocked by the remote user's XR device).

The XR device used by the host, or the control circuitry 220 and/or 228, may check for any restrictions that the host has placed, such as in their profile, in sharing the digital twin. Some examples of such restrictions may include not sharing physical display, not sharing virtual display, not sharing content with X, Y, Z genre, not sharing episode X, not sharing R-rated content, sharing only if the remote user has already consumed a previous episode. The host may also create an “if this then that” (IFTT) rule that may be analyzed by the XR device or control circuitry 220 and/or 228 prior to sharing. For example, the host may indicate that if a colleague, such as a work colleague, is a remote user in the watch party then the host may not wish to share certain private or inappropriate content items, such as content items that are rated R, personal vacations, gambling, etc.

The remote user that is joined into the watch party may also have restrictions on what they can consume. The XR device used by the remote user, or the control circuitry 220 and/or 228 associated with the remote user's XR device, may check for any restrictions that the remote user has placed, such as in their profile. The restrictions, in some embodiments, may be provided to the host's XR device such that content that is restricted by the remote user may not be shared with the remote user. In other embodiments, the XR device at the remote user's end may receive the digital twin and then remove content that is restricted and pass through only allowed content to be displayed on the screen of the remote user's XR device. To do so, image processing, editing, and other content-deletion techniques may be applied by the XR device at the remote user's end.

Among the examples of remote user restrictions depicted at block 1220, one of the restrictions may be to not display virtual displays if bandwidth is low. As such, the XR device at the remote user's end, or the control circuitry 220 and/or 228 associated with the XR device at the remote user's end, may determine bandwidth constraints. If there are any bandwidth constraints, then virtual displays that were shared by the hosting user as part of the watch party may not be displayed on the remote user's XR device. In another embodiment, one of the remote user's restrictions may be to only accept content that remote user Y approves. For example, if the remote user is a child, then they may seek approval from remote user Y, which may be a parent or other adult, prior to the content being allowed for consumption. In such a scenario, there may be restrictions placed on the XR device of the remote user to check for approval from remote user Y prior to allowing content to be displayed.

Various host and remote user restrictions may be placed by the host and remote users directly or they may be placed by the XR devices or control circuitry 220 and/or 228 automatically. For example, if the XR device or control circuitry 220 and/or 228 detects a pattern of restrictions from the previous watch parties, then such restrictions may also be applied to a current watch party.

FIG. 13 is a block diagram of an example of application/platform, host, and remote user preferences, options, and recommendations relating to sharing and consuming a shared digital twin, in accordance with some embodiments of the disclosure.

In some embodiments, a sharing application (app) or a sharing platform may be used for the watch party. Using the sharing app, the host may select content to share, identify remote users for joining the watch party, create spatial maps of the room, and share objects and displays (both physical and virtual) that are in the room where the hosting user is located when launching the watch party. The host and remote user may also be able to perform a plurality of functions using the sharing app/platform.

In some embodiments, the sharing app/platform may also provide recommendations. The recommendations, for example, may be determined based on results from executing an ML and/or an AI algorithm that is executed by an ML and/or an AI engine. Other sources may also be used for providing recommendations, such as host consumption history, what the host's contacts are consuming, what the host may have liked on social media, what the host may have discussed in their text messages, voice calls, chats, emails, etc. Since access may be provided to all such sources of data, the sharing app/platform may obtain such host data and either determine recommendations on its own or leverage AI and ML engines on the basis of such data to determine a recommendation for the host.

In some embodiments, as depicted at 1312, the sharing app/platform may recommend sending an invitation to certain remote users that are listed in the hosting user's contact list that may be stored at XR device or another device associated with or accessible by the XR device. The invitation may be for the remote user to join the watch party. The recommendation to invite certain users may be based on prior watch parties between the host and the remote user or some other prior communications between them based on which a determination may be made that the remote user may likely be interested in the content that the hosting user is currently consuming.

In some embodiments, as depicted at 1314, the sharing app/platform may recommend to the hosting user to share a particular stream. The sharing app/platform may obtain data relating to the displays in the room where the hosting user in located when launching the watch party, including displays within the FOV of the hosting user wearing/using the XR device and based on analysis of the obtained data may recommend to the host to share a stream with certain remote users based on events and shared content references/sharing history. For example, in response to a news alert or a score update in a game, the host of the watch party (who is wearing/using an XR device) might be recommended by the sharing app/platform to automatically share their extended reality experience that includes a specific spatial screen/display that has the news alert, or the game displayed. The sharing app/platform may also automatically share such alert with a specific user and provide an option to the hosting user to stop sharing. The sharing of the recommended display or stream may include sharing metadata, a clip, or a still image (such as the image depicted in FIG. 16) associated with the content being displayed. As described above, the recommendation to share may be based on a plurality of factors, including based on determining that the host's friend or friends are also watching the content.

In some embodiments, as depicted at 1316, when a watch party invitation is sent by the sharing app/platform to the remote users, the watch party invitation may include lists of content that the host is watching on one or more spatial screens in their spatially mapped environment. Sharing the lists of content that the host is watching with a remote user may allow the invited remote user to join (accept) or leave (reject) the invitation based on their interest in the content. Since rendering spatial environments is CPU- and bandwidth-intensive, such feature may benefit remote users that have no interest in the content being watched by the hosting user. In the event a remote user doesn't have the available bandwidth to join the multiscreen watch party that may involve viewing all content on all virtual screens, the remote user with limited bandwidth may choose which virtual screens/content they want to view in the watch party. If there is a bandwidth issue, the content provider, who may be partnered with an operator that allocates user bandwidth, may present a bandwidth upgrade as an upsell to the remote user to consume the content.

In some embodiments, as depicted at 1318, the sharing app/platform may enable the automatic acquisition of the stream. In this embodiment, a digital twin may be shared with a remote user. The shared digital twin may include metadata of a content item that is displayed on a display within the spatially mapped room. The sharing of the digital twin as well as metadata of a content item may be subject to any sharing criteria, restrictions, and preferences of the remote user (e.g., as depicted in blocks 104A and 104B of FIG. 1 and as described earlier in block 1220 of FIG. 12). The automatic acquisition of the stream may be based on stored remote user information (e.g., by utilizing the profile information in the subscriber management service). In other words, if the remote user has a subscription to the content for which metadata is shared during the sharing of the digital twin, then the stream associated with the content may be automatically acquired. In such case, the stream is acquired after the rendering of the spatial environment on the remote user's XR device. The stream may then be synched with the host's playout time to provide the host and the remote user an experience of watching content in the watch party together. The automatic acquisition of the stream may be performed by automatically retrieving the stream while processing the spatially shared environment (e.g., during the re-localizing process).

In some embodiments, as depicted at 1320, the sharing app/platform may provide an alert to the remote user with whom the digital twin is shared. In one embodiment, the hosting user may change the content on the spatial screen in their viewport. For example, during consumption of movie #1,the host may change to movie #2.Once a change is detected, the remote users joined into the watch party may be alerted of such change and prompted to also change. In one embodiment, a metadata service may be used. The metadata service may display or overlay information about the new content that the host switched to on part of the spatial screen (e.g., lower right corner).

In some embodiments, the hosting user and remote user may have equal privileges, e.g., they may be equal peers, and therefore be able to control the display of their own content on the spatial screens. The configuration of the sharing session may be defined by the host where the host defines roles for remote users, e.g., what content the remote users can and cannot change in their received digital twin. In other embodiments, the hosting user may place restrictions on trick play on at least one of the spatial screens. Accordingly, trick-play restrictions placed by the host may disable trick-play control for the remote users. Even though the remote users may acquire the stream using their own credentials (e.g., their own subscription to the content provider, such as Netflix), accepting the host's streaming requirements can disable trick-play functionalities (e.g., fast-forward or play at faster speed) until the session ends.

In another embodiment, the host and remote users may be streaming content from the same source. In this embodiment, the session IDs may be known. Accordingly, if the host places trick-play restrictions, then the sharing app/platform, or control circuitry 220 and/or 228 of system 200 in FIG. 2, may automatically place the trick-play restrictions on the remote user's session ID. In another embodiment, the sharing app/platform or a service, such as Netflix, may also place the trick-play restrictions on the remote user's session ID.

In another embodiment, the host and remote users may be streaming the same content (e.g., on-demand movie) from different sources and/or different content providers. In such embodiments, forcing different content sources to place trick-play restrictions may be challenging if the sharing app/platform is not configured to communicate with each remote user's content provider. As such, the host or the sharing app/platform may first determine whether content is available from the same service or provider, and if so, choose that as the first option to provide them with higher level of restriction control. Once playback restrictions are placed on content playback by the host, then performing a trick-play functionality by the host may also result in performing the same functionality for the remote user, e.g., if the host fast-forwards a segment on their end, the same fast-forward may be performed on the remote user's end.

In some embodiments, as depicted at 1322, the sharing app/platform may prompt the host to reconfigure their spatial environment in response to detecting a share intent (e.g., after host presses the share button or performs certain other functions to activate sharing). In such embodiments, the host may remove a spatial screen they don't wish to share or even change the content displayed on such screen or screens.

In other embodiments, any of the virtual content/objects in the host's environment may be considered private if the host deems them to be private. As such, the sharing app/platform may block such private content/objects from the remote user. In some embodiments, the implementation of such blocking may include sharing the spatially mapped environment with the remote user. However, when the spatially mapped environment is shared and rendered on the XR device of the remote user, the remote user may see a different object that has the same size as the private content/object but not the details, since the content/object was deemed private by the host. In other words, the private object may be replaced with an equal sized object. In another embodiment, the implementation of such blocking may include overlaying another object on top of the content/object that is to be hidden or blocked. In yet another embodiment, in-painting techniques may be used to erase the content/object and paint it with a background. Other embodiments may include placing a restricted sign, shading over the content/object, or placing a black/grey or other colored texture over the content/object to hide it, or some other form of masking the object/display that is to be hidden or blocked.

In some embodiments, as depicted at 1324, the sharing app/platform may recommend to the host to turn off certain spatial screens based on the identity of the remote user with whom the host is sharing the digital twin and content within the digital twin. For example, in one setting, sharing is a social feature and users normally share or conduct a group watch with people that they are friends with (e.g., on a social network). Since they are sharing with friends or family, the hosting user may not hide anything that is in the digital twin.

In other embodiments, the sharing app/platform may have metadata about the remote user's content preferences, subscription plans, and even content restrictions imposed by parental control settings. The metadata be stored in the remote user's profile and shared with the sharing app/platform. Since the remote user may access their content through a service provider such as Netflix, the service provider may already generate and store metadata relating to the remote user's content preferences, subscription plans, based on the remote user's consumption via the Netflix app. For example, if person A is the host, and intends to share their AR viewing experience with person B, person A might be recommended to change the content on one more of their spatial screens if it is determined that person B can't access the content or is not authorized to access the content. Person B might have access to the source (e.g., content provider that host A is using to consume the content, such as Netflix), but person B may not be able to access the content due to content restrictions on their profile. Additionally, sharing spatial screens that are displaying geo-restricted streams might not work for remote users in different regions or time zones, since the media service that these remote users may use to retrieve the corresponding stream might not be offering that stream. Even if the remote user's may have access to the applications that the host is using, that content might not be available for viewing at the remote user's location (e.g., Netflix or HBO may not provide same show in two different countries like United States and India). As such, the sharing app/platform may determine any subscription, parental restrictions, geographical and other restrictions prior to sharing content displayed on a spatial screen of the digital twin. In addition to the subscription, parental restrictions, geographical and other restrictions, the sharing app/platform, as depicted at 1326, may evaluate all restrictions and preferences, such as those depicted at blocks 104A and 104B of FIGS. 1 and 1210 and 1220 of FIG. 12, prior to sharing content from a spatial screen.

In some embodiments, as depicted at 1328, the sharing app/platform may recommend which content to play/replace to the host. For example, the sharing app/platform may recommend replacement of a currently playing movie on spatial screen “front right living room” with the movie “The Guilty” which is accessible to the remote user that the host intends to invite. The media application itself (e.g., Netflix) might also recommend (before sharing) what content to play. For example, if a remote user has a subscription to access movie #2 and not movie #1, then Netflix may recommend that the hosting user play movie #1. The sharing app/platform or the service provider may also determine the genre of movie #1 and select movie #2 that matches the same genre prior to making the recommendation.

In some embodiments, as depicted at 1330, the sharing app/platform may determine consumption by each remote user that has joined the watch party. For example, the sharing app/platform may determine the remote user A is consuming spatial screen A while remote user B is consuming spatial screen B.

In some embodiments, the sharing app/platform may also determine that a majority of remote users joined into the watch party are consuming spatial screen C. When a determination is made that the majority of users are consuming spatial screen C, then the sharing app/platform may send a notification message to the host, all remote users, and/or the remote users not looking at the same spatial screen, in an attempt to have them also consume or direct their attention to spatial screen C. Such consumption data may be obtained by the sharing app/platform accessing a camera of all the remote users' XR devices and tracking the remote users' eyeballs to determine their lines of sight. Based on the lines of sight, the sharing app/platform may determine which spatial screen is being consumed by the remote users.

In some embodiments, once a determination is made what the majority of remote users are consuming, the XR device of each remote user not consuming the same spatial screen may provide an indicator directing the minority remote users to the zones or spatial screens that the majority of users in the multiuser watch party are watching. Based on eye tracking, even within a zone, an indicator like a highlighted outline may be placed around the spatial screen that the majority of users are watching. If the majority of invited users are watching the virtual representation of a physical display/TV, a highlighted border may be placed around the physical TV/device in the viewport of the host's XR device.

Referring now to host preferences and functions that may be performed by the host of the watch party 1340, including those functions that may be initiated by the host and continued by the system, such as the system in FIG. 2, in some embodiments, as depicted at 1342, a host may desire to share a digital twin of their environment with remote users in the watch party, such as, for example, the digital twin in its entirety without hiding any displays. To implement the sharing of the digital twin, spatial map/layout coordinates may be obtained or generated. The host's device may then share the generated spatial map/layout coordinates with remote users that are joined into the watch party. The spatial map/layout coordinates may be loaded (e.g., to a cloud-based service) and rendered on the XR devices of the remote users. The spatial screens, which are part of the shared digital twin, may not show the content items displayed on the host's spatial screen at this point. Instead, they may only display metadata associated with the content being watched by the host. For example, if a spatial screen/display that is in the spatially mapped room of the host's XR device is playing movie #1, then, instead of sharing the playing of the movie, metadata associated with the movie may be shared. In some embodiments, a clip or a screen shot may also be shared. In other embodiments, as depicted at 1344, special graphics for the content (e.g., posters) may be obtained and displayed, such as the poster for the movie “The Last Duel,” which may be an official poster of the movie, as depicted in FIG. 16. Once the remote user receives the metadata, the remote user may be able to access a stream associated with movie #1 if they have subscription to a service provider that offers movie #1. If the remote user does not have the subscription, this may provide an opportunity to the service provider to upsell them on a subscription that does contain movie #1.

In some embodiments, as depicted at 1346, the host may be able to designate one of the spatial screens (or a physical TV) as the primary screen. Accordingly, the content on such screen may be identified as the primary content. For example, during the watch party, a physical display 820 from FIG. 8 and a plurality of virtual displays 830-880 may be visible. All the physical and virtual displays may be shared with the remote users as part of the digital twin. The host may then designate any of the displays 820-880 as a primary screen. Once the primary screen is designated, the control circuitry 220 and/or 228 of the system in FIG. 2, or the sharing app/platform, may determine bandwidth issues and/or hardware capabilities at each remote user's side. The bandwidth issues and/or hardware capabilities may also be predetermined prior to the hosting user selecting the primary screen. In other embodiments, because there may be bandwidth issues and/or hardware capabilities at the remote user's end, the control circuitry 220 and/or 228 of system 200 in FIG. 2, or the sharing app/platform, may recommend that the host select a primary screen.

Once the bandwidth issues and/or hardware capabilities at the remote user's end are determined, a determination may be made whether there is enough bandwidth at the remote user's end to consume all the displays shared in the digital twin. If there isn't enough bandwidth, in some embodiments, the remote user may choose to watch only the primary content designated by the host and not load the rest of the stream (i.e., the secondary streams) associated with content items displayed on the other screens/displays shared (e.g., watch only content from display 820 and not from displays 830-880). Based on the bandwidth issues and/or hardware capabilities at the remote user's end, the control circuitry 220 and/or 228, or the sharing app/platform, may also just display content items from some of the displays (e.g., from displays 820 and 850 and not from displays 830-840 or 860-880). In some embodiments, physical TVs/displays/screens may be set as default for the primary content source(s) if one (or more) is not indicated.

In some embodiments, the hosting user may prioritize the physical TVs/displays and the virtual displays in descending or ascending order or some other order. The prioritization may also be based on level of interest or action taking place in the content displayed, e.g., a physical display that is showing a climax of a movie, a close ending of a game, or a team about to score a touchdown may automatically get a higher order and priority (even if it was a low order or priority before). As such, the type of action in the content item may be monitored and analyzed by the system to determine priority. The priority may be taken into consideration when rendering the digital twin at the remote user's XR device. For example, if the remote user does not have sufficient bandwidth, then only the content item with top most priority may be rendered and then the next in priority until there isn't enough bandwidth to render the lower priority items.

In some embodiments, a determination may be made by the XR device, or associated systems, at the remote user's end whether there is sufficient bandwidth and/or hardware capability to allow rendering of the digital twin that includes the content from all of the physical TVs/displays and the virtual displays. In some embodiments, if a determination is made that there is sufficient bandwidth and/or hardware capability to allow rendering of the digital twin that includes the content from all of the physical TVs/displays and the virtual displays, only then will the remote user be joined into the watch party. The remote user will not be joined if there isn't enough bandwidth or hardware capability.

In some embodiments, on the displays where the bandwidth is not available, a screen saver or info from the content provider advertising the content may be displayed. If bandwidth availability or hardware capabilities are not available for the remote user joining the watch party, the remote user, in their XR device, may be provided an option to select which content to be viewed.

In some embodiments, as depicted at 1346, the host may prioritize a display screen or zones within the shared digital twin. Zones that include a physical TV/display may be given automatic priority over other zones. The hosting user may also prioritize zones in descending or ascending order or in an order of interest. For zones, the quality of experience (QoE) weighting factor may be a way for setting the zone priority. For example, the higher the QoE weighting factor, the higher the zone priority assigned to the zone. Likewise, for display screens, the host may designate a primary screen and prioritize that to be at the topmost priority.

In some embodiments, as depicted at 1348, the hosting user on their XR device may be able to select a zone or a display screen to share with which remote users joining the watch party. For each zone, the hosting user may view a list of users and select a subset of the users invited to the watch party to view the zone. Such selection may be made by the host using any physical or virtual display or directly on the XR device used by the host during the watch party. In some embodiments, the remote users may also be able to select which zones they choose to watch in the watch party. For example, the remote users may choose to watch only virtual displays in the watch party.

In some embodiments, for the displays or zones the remote user chooses not to watch, the displays or zones may be removed from the remote user's XR device, thereby saving bandwidth and computing resources at the remote user's end. In some embodiments, the system may place a still image over a display not used, such as a still image of a movie that is being shown to conserve bandwidth. The remote user may choose to come back to the display not being watched and start watching it. The system may track the remote user's gaze and, based on the remote users gaze being directed towards the display (which was not being watched by the remote user), automatically remove the still image and replace it with a live content stream. As such, the system may constantly replace live streams with still images, or still images with live streams, based on the consumption of the remote user, to actively manage the overall utilization of bandwidth.

In some embodiments, as depicted at 1350, the host might want to watch one content item with the person that he is sharing the AR experience with. However, that content might be displayed on a spatial screen that is not prominent within the host's XR device. As such, the system may recommend to the host to relocate the stream to a more prominent spatial screen—e.g., a bigger spatial screen in the extended reality environment. The system, upon approval from the host, may automatically relocate the streams (e.g., swap the streams on two spatial screens to make the desired stream the prominent stream).

In some embodiments, as depicted at 1352, the host may approve sharing of list of content items with remote user. Sharing such list may allow the remote user to decide whether the content on the list is of interest and then decide whether to join the watch party.

In some embodiments, as depicted at 1354, the host may turn on/off a display screen as desired at any time. For example, a host may decide to no longer share the display screen for any reason. An example of a reason may be the content playing on that screen has ended and new content is being displayed which the host no longer wants to share with the remote user.

In some embodiments, as depicted at 1356, if the content is time-shifted or VOD controlled, the hosting user may be able to set a limit on the number of users required to look at the time-shifted or VOD content when the hosting user is looking at the time-shifted or VOD content for resuming play from the pause state. The system or sharing platform may also implement such time-shifted or VOD controls automatically. Upon implementation, when the hosting user looks at the paused content, a notification may be sent to all remote users. The notification may indicate that the host is looking at the paused content. The sharing app may also provide a directional indicator prompt in the remote user's XR device with a directional indicator for changing their view to the paused content. Once the threshold number of remote users is reached viewing the paused content, the content may resume playout from the paused state. The hosting user may override the play or pause at any time.

Referring now to remote user preferences and functions 1360 that may be performed by the remote user joined into the watch party, including those functions that may be initiated by the host and continued by the system, such as the system in FIG. 2. In some embodiments, as depicted at 1362, the remote user may determine which spatial screen to activate, if there are multiple spatial screens available (i.e., shared as part of the digital twin). As referred to herein, the term “activation” is equivalent to “stream acquisition” and may include all the necessary steps (search, authentication, authorization, requesting playback, retrieving manifest file, requesting segments, buffering/decoding/rendering or displaying) required to acquire a stream from various sources (e.g., broadcast, OTT, etc.). In some embodiments, the hosting user may not want to share the metadata of one or more of his or her spatial screens, which may be private. In such embodiments, even if the spatial coordinates/tag of that spatial screen is shared with the remote user, the metadata that is shared is defaulted to metadata associated with a screen saver such as pictures (e.g., from a social feed, etc.). A service may also be used, such as a metadata service, that may default to showing a random screensaver, or graphics, when a detection is made that the shared screen is private for the hosting user.

In some embodiments, as depicted at 1364, the remote user may determine whether they would like to consume the content identified via the metadata in the digital twin synchronously with the hosting user or in a time-shifted manner. They may also be directed by the host. For example, as described above, in some embodiments, the host may provide privileges to the remote user to watch live or in a time-shifted manner and grant the remote user the ability to control the display of their own content on the spatial screens. In other embodiments, the host may restrict the remote user such that they may consume the shared digital twin and all content within only synchronously with the host. The host may also allow the remote user to perform their own trick-play functions or reserve those for host to control.

In some embodiments, as depicted at 1366, the remote user may determine their primary display. For example, if the hosting user shares multiple screens as part of the digital twin with the remote user, the remote user may identify one of the screens as their primary screen for consumption. In some embodiments, the primary screen may be automatically identified by the system based on the remote user's gaze. For example, if the system determines that the remote user's line of sight is directed towards a virtual display VR2, such as at 1830 in FIG. 18, then the system may automatically make VR2 as the primary display for the remote user.

In some embodiments, as depicted at 1368, the remote user may exit the watch party at any time. If the remote user decides to rejoin the watch party, the remote user may do that by sending a request to the hosting user to allow the remote user to join back into the watch party. In some embodiments, the hosting user may also remove or kick out a particular remote user from the watch party.

FIG. 14 is flowchart of a process 1400 for preloading content for the remote user that is joined into the watch party, in accordance with some embodiments of the disclosure. The process 1400 may be implemented, in whole or in part, by systems or devices such as those shown in FIG. 2-3. One or more actions of the process 1400 may be incorporated into or combined with one or more actions of any other process or embodiments described herein. The process 1400 may be saved to a memory or storage (e.g., any one of those depicted in FIGS. 2-3) as one or more instructions or routines that may be executed by a corresponding device or system to implement the process 1400.

In some embodiments, process 1400 may be implemented for remote users that accept an invitation to an extended reality multiuser watch party. The process may be applied to preloading or loading the spatial data shared by the hosting user's XR device to support rendering the digital twin of the hosting user's room along with spatial coordinates of all zones, zone layouts, physical TVs/displays and AR virtual TVs, all spatial tags for all zones, virtual representations for physical TVs/devices and AR virtual TVs/devices at the remote user's end (i.e., on the remote user's XR device subject to any restrictions and preferences as described in FIGS. 12 and 13).

The process may include, in some embodiments, at block 1405, an invitation being sent to the remote user to join a watch party. The invitation may be sent by the host directly to a particular remote user, such as by the host selecting individuals in their contact list. The invitation may also be sent automatically by the XR device or the control circuitry 220 and/or 228 based on a plurality of factors. These factors may include the host inviting the same remote user to a previous watch party, the host sharing an interest with the remote user for a particular genre of content items that the host is going to be consuming, or communications between the host and the remote user, such as via text, emails, chats, etc.

At block 1410, the XR device may receive an acceptance from the remote user that was invited to join the watch party.

At block 1415, it determination may be made whether the invitation is for a future watch party or an immediate watch party. If a determination is made that the invitation is for a future watch party, then, at block 1420, a determination may be made whether the remote user's XR device is already online. If it is already online, then, at block 1425, another determination may be made whether the remote user's XR device has the hosting user's spatial data, in other words, the host's spatial data has already been transmitted to the remote user's XR device and downloaded.

If a determination is made at block 1415 that the invitation is for an immediate watch party, then, at block 1430, a determination may be made whether the remote user's XR device has the hosting user's spatial data.

If a determination is made at blocks 1425 and 1430 that the remote user's XR device already has the hosting user's spatial data, in other words, the remote user's XR device already includes the spatial data needed to join the watch party and receive the digital twin, then the process may move to block 1460, where the remote user's XR device downloads virtual display spatial data to the cloud

If a determination is made at either block 1425 or 1430 that the remote user's XR device does not already have the host's spatial data, then the process may move to block 1435, where the XR device may download, and store compressed texturized point cloud on the XR device.

In some embodiments, at block 1440, the XR device may uncompress the downloaded texturized point cloud data.

At block 1445, the remote user's XR device may download spatial coordinates for all zones that are defined in the spatial data. It may also download all policies associated with each zone from the cloud.

At blocks 1450-1455, for all virtual displays that were identified by the host or the host's XR device, the XR device may download virtual display spatial data to the cloud. This spatial data includes spatial definition coordinates with spatial tag coordinates for the virtual displays. The spatial data is stored under the remote user account to the cloud.

At block 1460, the set stage may be ready for the remote user to join the watch party.

FIGS. 15A and 15B are a flowchart of a process 1500 for loading a digital twin and providing access to content on the displays shared in the digital twin based on a remote user's subscription level, in accordance with some embodiments of the disclosure.

The process 1500 may be implemented, in whole or in part, by systems or devices such as those shown in FIG. 2-3. One or more actions of the process 1500 may be incorporated into or combined with one or more actions of any other process or embodiments described herein. The process 1500 may be saved to a memory or storage (e.g., any one of those depicted in FIGS. 2-3) as one or more instructions or routines that may be executed by a corresponding device or system to implement the process 1500.

Process 1500 may be used for remote users who accept a extended reality multiuser watch party for preloading or loading the spatial data to support rendering the digital twin of the hosting user's room along with spatial coordinates of all zones, zone layouts, physical TVs/displays, AR virtual TVs and all spatial tags for all zones, virtual representations for physical TVs/devices and AR virtual TVs/devices.

In some embodiments, process 1500 may be initiated when a detection is made at block 1501 that a remote user has joined a watch party. The detection may be made by the XR device of the hosting user or a server that manages the watch party platform.

At block 1503, a determination may be made whether the remote user's XR device is state ready to join the watch party, in other words, whether the XR device of the remote user already has all the spatial and other data needed for the remote user to join the watch party.

If a determination is made at block 1503 that the XR device associated with the remote user is not state ready to join the watch party, then, at block 1505, the XR device may be required to wait until the state is ready for the XR device to join the watch party. In other words, the XR device may have to wait until to join the watch party until spatial and other data needed for the remote user to join the watch party is made ready.

If a determination is made at block 1503 that the XR device associated with the remote user is state ready to join the watch party, then, at block 1507, the XR device may load texturized point cloud (TPC) data on the remote user's XR device.

At blocks 1509 and 1511, the remote user's XR device may load spatial coordinates for the zones and zone layouts. For example, if the spatial layout includes a plurality of zones, such as the zones depicted in FIG. 10 or FIG. 16 (e.g., 1610 or 1630), then the XR device may load spatial coordinates for all the zones defined.

At block 1513, for all the virtual displays identified by the hosting user, the remote user's XR device may load virtual spatial definition coordinates along with spatial tag coordinates associated with the virtual displays to the cloud (as depicted at block 1515). It may also load them to a remote storage associated with the remote user's XR device.

At block 1517, the remote user's XR device may render a texturized spatial map and virtual displays at spatial point tags. The rendering may be performed on a screen of the remote user's XR device. Once the texturized spatial map and virtual displays are rendered, process 1500 may include determining whether the remote user has a subscription to the service provider that will be providing the content item for the remote user's consumption. For example, if the hosting user shares a movie, “The Last Duel,” as part of the digital twin shared, and the sharing app provides metadata that include a link to access the movie from a service provider, such as Netflix, then the remote user's subscription level that allows them to access a stream for the “The Last Duel” may be evaluated. If the remote user has the necessary subscription, then the stream may be provided. Otherwise, Netflix may upsell the subscription to the remote user. The process of evaluating the subscription and providing the stream is described in FIG. 15B below.

In some embodiments, at block 1519 of FIG. 15B, for all virtual displays defined by the hosting user, the remote user's XR device may request the content items for each of the virtual displays from the content provider for displaying on the XR device. This is the same content item that is displayed on the display in the host's environment and shared with the remote user as part of the digital twin (e.g., metadata for the content item may have been shared as part of the digital twin).

At block 1523, in some embodiments, a determination is made whether the remote user has subscription to access the content item. As described earlier, this is the same content item that was shared in the digital twin by the hosting user's XR device.

If a determination is made at block 1523 that the remote user does have the required subscription to access the content item, then, at block 1525, the remote user's XR device may request the content item from the content provider by accessing a content provider's app loaded onto the XR device or another device that is communicatively connected to the XR device.

If a determination is made at block 1523 that the remote user does not have the required subscription to access the content item, then, at block 1535, the content provider may prompt the remote user to purchase the subscription. This may be an opportunity for the content provider, such as Netflix, to sell a subscription or upsell to an upgraded subscription that will then provide the remote user access to the requested content item.

If a prompt is provided for purchasing the subscription, then, at block 1537, a further determination may be made whether the remote user has actually purchased or subscribed to the subscription offer provided by the content provider.

If a determination is made at block 1537 that the remote user has not purchased the subscription offered by the content provider, then, at block 1539, the content provider may display a still image 1620 (as depicted in FIG. 16 of the movie, The Last Duel) of the content item and the subscription offer. The content provider may also provide further incentives for the remote user to purchase the subscription. For example, the content provider may provide certain discounts or a limited trial offer for free to the remote user.

If a determination is made at block 1537 that the remote user has purchased the offered subscription, then the process may move to block 1525, where the XR device of the remote user may request the content item through the content provider's app.

At block 1527, once the XR device's request for the content item has been made, the playout time is synchronized with the host. In other words, the synchronization may allow the hosting user and the remote user to watch the content item together. In some embodiments, the platform associated with the watch party may also inform the hosting user and/or the remote user of the progress of each user's consumption of the content item.

After synchronizing the playout time with the hosting user, the control circuitry may continue to monitor the playing of the content item. In some embodiments, as depicted at block 1529, a determination may be made whether the content item is playing or paused. If a determination is made at block 1529 that the content item is playing, i.e., it is continued to be played after it has been synchronized with the host at block 1527, then, at block 1531, the playout time for the remote user may continue to be synchronized with the hosting user's playout time. If a determination is made at block 1529 that the content item is paused, e.g., after initially being played and synchronized, then, at block 1533, the remote user's playout paused location may be synchronized with the host's playout paused location.

FIG. 16 is a block diagram of a still image 1620 being shared in the digital twin, in accordance with some embodiments of the disclosure. As described earlier, in one embodiment, when a digital twin is shared with the remote user, any displays that are in the shared digital twin are made available to the remote user via their XR device. With respect to sharing of the content items displayed on the displays, metadata, which may include a link, text, video clip, or trailer associated with the content item, may also be shared. In some embodiments, if bandwidth constraints of the remote user are detected that may prevent playing of a trailer or a video clip related to the shared content item, the still image, such as the still image of the movie “The Last Duel,” may be shared.

In other embodiments, when the remote user selects the metadata or the link in the metadata to access the content item from the content provider, it may be that the remote user does not have a subscription to access the content item. In such circumstances, the content provider may provide a still image of the content item, sometimes along with a subscription offer, to entice the remote user to buy or upgrade their subscription.

FIG. 16 also depicts zones 1610 and 1630 which may also include displays. Content from such displays may also be presented as still images, for example, if the remote user doesn't have subscription to access such content or does not have bandwidth to play the content. A combination if still and video may also be presented to the remote user.

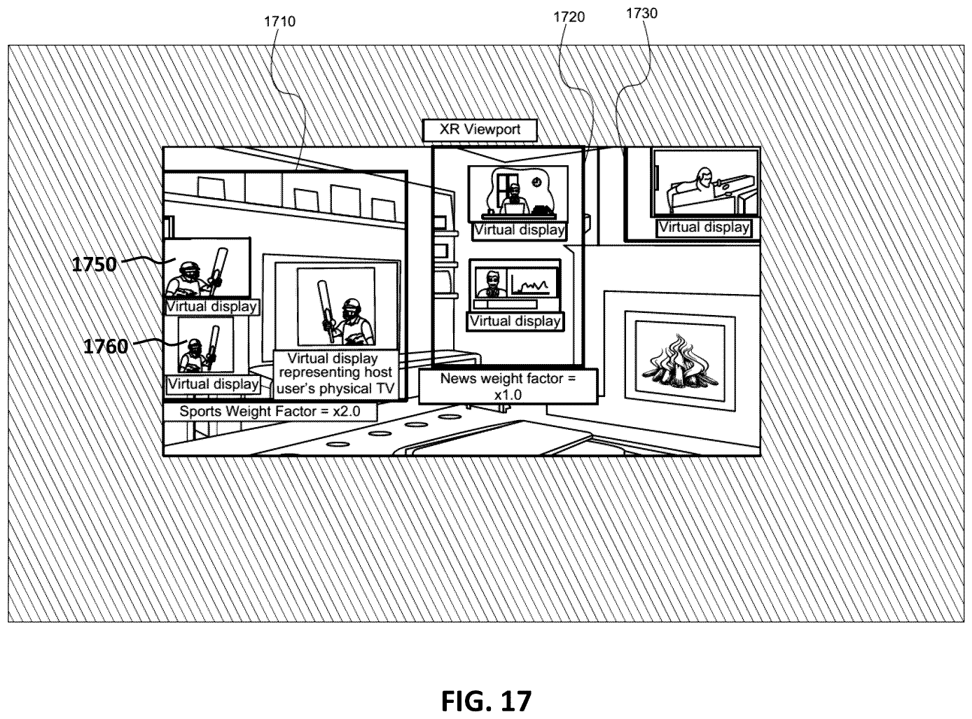

FIG. 17 is an FOV from the hosting user's XR device, in accordance with some embodiments of the disclosure. As described earlier, in some embodiments, a digital twin which is a replica of the host's environment may be shared with the remote user's XR device. The remote user may access different portions of the digital twin as they orient their XR device from one orientation to another. In another embodiment, the FOV from the hosting user's XR device may be shared with a plurality of remote users, subject to restrictions and their preferences. Once shared, in one embodiment, the remote user may be able to view a replica (i.e., the digital twin) of what the hosting user can see through the FOV of their XR device. Once shared, in another embodiment, the remote user may be able to view a replica of the host's environment in its entirety, i.e., whatever is in the spatially mapped room and shared subject to restrictions and preferences, regardless of whether it is in the FOV of the hosting user's XR device.

One example of such a shared replica is depicted in FIG. 17. In this embodiment, the hosting user, via their XR device, may be able to see some portion of their room that includes, on the left side, the virtual displays and physical TV display that are displaying sports-related content items, the virtual displays in the middle of the FOV, which are displaying content items that are news related, and a separate content item with a different genre on the right side of the FOV. The hosting user, via the FOV of their XR device, can also see some objects in the room, such as the fireplace, the shelf with pictures on top, etc. All such displays and objects in the exact same location may be visible in the remote user's XR device once the digital twin is shared.

In some embodiments, the hosting user wearing the XR device may orient their head so that their FOV changes. When such a change occurs, the new FOV may be automatically displayed in the remote user's XR device as well. Since the spatial map may already contain the entire layout of the room, as the FOV of the hosting user continues to change, the spatial map may be accessed to render the new FOV to the remote user.

In some embodiments, the hosting user may create a policy that if a partial display is visible in the FOV of the hosting user's XR device, then such display shall not be shared with the remote user. If such a policy is generated and implemented, then the virtual TVs 1750 and 1760, which are only partially visible in the hosting user's FOV, may not be share with the remote user.

FIG. 18 is a block diagram of host and remote user's gazes and consumption of content on display during the watch party, in accordance with some embodiments of the disclosure.

As depicted in FIG. 18, in some embodiments, remote user R1 1820 may be directing their gaze towards physical TV1, remote user R2 1830 may be directing their gaze towards virtual display VR2, and likewise, remote user R3 1840 may also be directing their gaze towards virtual display VR2. An avatar of each of the remote users 1820-1840 may be displayed on the host's XR device. The display of the avatar may be overlayed on the display that the associated remote user is currently consuming. For example, since remote user R1 1820 has his gaze directed at physical TV1, an avatar of the remote user R1 1820 may be displayed in the host's XR device overlayed on the physical TV1. By doing so, the host may be made aware of which display (and content item displayed on the display) is being consumed by the remote users. Obtaining data relating to consumption by other users may provide a plurality of options both to the hosting user as well as watch party platform. For example, if a determination is made that a particular display is not being looked at by any of the remote users, even though it's in their FOV, then the host's XR device may alert the hosting user that content being displayed on that particular display is likely not of interest to any of the remote users. The XR device may also provide recommendations for replacement content on the display that is not being consumed.

To determine what each remote user is consuming, in some embodiments, the control circuitry 220 and/or 228 may determine the line of sight (LOS) (also referred to as gaze or remote user's gaze) of the remote user from their XR device. In one embodiment, the LOS may be narrower than the FOV, and it may determine on a granular level where within the FOV the sight is focused. In one embodiment, the control circuitry 220 and/or 228 may determine the LOS based on the current transitional and orientational location of the remote user's XR device. In another embodiment, the control circuitry 220 and/or 228 may utilize an inward-facing camera that can monitor and detect the movement of the remote user's eyeballs to determine the LOS. In other words, the inward-facing camera may be used to detect the gaze of the remote user's eyeballs and determine where within the FOV the gaze is focused. The inward-facing camera may also be used to determine depth perception of the remote user's eyeballs and determine whether the gaze is focused on a near or far display or object that is within the FOV and within the shared digital twin.

In another embodiment, when a majority of users are watching a shared viewing space, a notification message may be sent to another remote user's XR device who is not looking at the same display or zone as the majority. For example, as can be seen in FIG. 18, all the users except remote user R1 1820 have their gaze focused on virtual display VR2. As such, an alert may be sent to remote user R1 1820 informing him that majority of the remote users are looking at virtual display VR2. The XR device may also guide the remote user not looking at virtual display VR2 with virtual arrows displayed inside their XR device to the location where virtual display VR2 is located. The XR device may also provide other indicators directing the minority user to the zones or displays that the majority of users in the multiuser watch party are watching. Based on eye tracking, even within the zone, an indicator like a highlighted outline may be placed around the virtual display that the majority of users are watching, e.g., virtual display VR2. If it is the user hosting the multiuser watch party and the majority of invited users are watching the virtual representation of a physical display/TV, a highlighted border may be placed around the physical TV/device in the XR viewport of the hosting user.

It will be apparent to those of ordinary skill in the art that methods involved in the above-mentioned embodiments may be embodied in a computer program product that includes a computer-usable and/or -readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. For example, references are made to sharing only what is in the FOV of the host's device, or displaying what is currently visible to the hosting user via their XR device. The embodiments are not so limited and apply to sharing of the entire digital twin. In other words, regardless of the FOV from the hosting user's XR device, and regardless of whether the hosting user is even in the room after launching the watch party, once the room is spatially mapped and shared, it may be made available to the remote user in its entirety, subject to any sharing restrictions. As such, even if certain displays and objects in the spatially mapped room are not in the current FOV of the hosting user's XR device, the remote user may still be able to access any portion of the spatially mapped room, subject to any restrictions and preferences, such as those described in FIGS. 12 and 13.

Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
establishing a watch party between a host extended reality (XR) device and a plurality of remote XR devices;
spatially mapping a room in which the host XR device is located during the watch party, wherein spatial mapping includes generating a spatial map of the room that identifies a spatial location of one or more displays in the room and spatially anchors them to a selected spatial anchor;
generating a replica of the spatially mapped room;
determining sharing restrictions associated with sharing of the replica of the spatially mapped room; and
rendering the replica of the spatially mapped room on a remote XR device, from the plurality of remote XR devices, based on the determined sharing restrictions.

2. The method of claim 1, wherein establishing a watch party comprises:
transmitting a request to join a watch party to the plurality of remote XR devices; and
establishing a watch party with those plurality of remote XR devices from whom an acceptance to the transmitted request to join has been received.

3. The method of claim 1, further comprising:
sharing the replica of the spatially mapped room with a first remote XR device, from the plurality of remote XR devices;
determining that the shared replica includes either a physical or virtual display that is playing a content item; and
in response to determining that the shared replica includes either a physical or virtual display that is playing the content item, sharing metadata of the content item with the first remote XR device.

4. The method of claim 1, further comprising, determining whether the first remote XR device is enrolled in a subscription plan with a service provider that is associated with providing the content item that will allow the first remote XR device to access a video stream associated with the content item from the service provider.

5. The method of claim 4, further comprising:
determining that the first remote XR device is not enrolled in the subscription plan with the service provider that will allow the first remote XR device to access the video stream associated with the content item; and
in response to determining that the first remote XR device is not enrolled in the subscription plan with the service provider, causing a transmission of a subscription offer related to the subscription plan to the first remote XR device for purchase.

6. The method of claim 1, further comprising:
sharing the replica of the spatially mapped room with a first remote XR device, from the plurality of remote XR devices;
determining that a physical display in included in the shared replica of the spatially mapped room and that the physical display is displaying a live broadcast; and
in response to determining that physical display is displaying a live broadcast:
causing automatic acquisition of a stream associated with the live broadcast for the first remote XR device.

7. The method of claim 6, wherein the automatic acquisition of the stream associated with the live broadcast is performed if the first XR device has a subscription agreement with a service provider that is offering the live broadcast.

8. The method of claim 1, further comprising:
sharing the replica of the spatially mapped room with the plurality of remote XR devices, wherein the shared replica includes metadata associated with content items playing on one or more physical displays and virtual displays that are located in the spatially mapped room;
determining which content items are being consumed by which remote XR devices, from the plurality of remote XR devices, wherein the content items are accessed by the remote XR device via the metadata; and
displaying, on a screen of the host XR device, avatars of remote users associated with the plurality of remote XR devices, wherein the avatars are overlayed on the one or more physical displays and virtual displays that are being consumed by the remote XR devices.

9. The method of claim 1, further comprising:
determining a number of displays included in a shared replica of the spatially mapped room with a first remote XR device, from the plurality of remote XR devices;
determining bandwidth allocations for the first remote XR device with whom the replica of the spatially mapped room is shared; and
based on the determined bandwidth allocations, determining whether content items displayed on the number of displays included in the shared replica of the spatially mapped room can be streamed to the first remote XR device.

10. The method of claim 9, further comprising:
determining that the bandwidth allocated for the first remote XR device does not allow streaming of content items displayed on the number of displays included in the shared replica of the spatially mapped room digital copy; and
in response to determining the bandwidth allocated for the remote XR device does not allow streaming of content items displayed on the number of displays included in the shared replica of the spatially mapped room, sharing a still image of one or more content items.

11. The method of claim 1, wherein the generated spatial map includes a plurality of zones.

12. The method of claim 11, further comprising:
determining that a first zone, from the plurality of zones, is private and not to be shared with the plurality of remote XR devices; and
masking the first zone to prevent it from being rendered on the plurality of remote XR devices.

13. The method of claim 1, further comprising rendering a first content item on a first remote XR device in response the first remote XR device selecting metadata for the first content item displayed on a physical or virtual display shared as part of a shared replica of the spatially mapped room.

14. The method of claim 1, further comprising:
determining rendering preferences of a first remote XR device, from the plurality of remote XR devices; and
rendering the spatially mapped room based on the rendering preferences.

15. The method of claim 1, wherein the spatial map of the room identifies a spatial location of all objects and persons in the room and spatially anchors them to the selected spatial anchor.

16. A system comprising:
communication circuitry configured to access a host extended reality (XR) device; and
control circuitry configured to:
establish a watch party between the host extended reality (XR) device and a plurality of remote XR devices;
spatially map a room in which the host XR device is located during the watch party, wherein spatial mapping includes generating a spatial map of the room that identifies a spatial location of one or more displays in the room and spatially anchors them to a selected spatial anchor;
generate a replica of the spatially mapped room;
determine sharing restrictions associated with sharing of the replica of the spatially mapped room; and
render the replica of the spatially mapped room on a remote XR device, from the plurality of remote XR devices, based on the determined sharing restrictions.

17. The system of claim 16, wherein establishing a watch party comprises, the control circuitry configured to:
transmit a request to join a watch party to the plurality of remote XR devices; and
establish a watch party with those plurality of remote XR devices from whom an acceptance to the transmitted request to join has been received.

18. The system of claim 16, further comprising, the control circuitry configured to:
share the replica of the spatially mapped room with a first remote XR device, from the plurality of remote XR devices;
determine that the shared replica includes either a physical or virtual display that is playing a content item; and
in response to determining that the shared replica includes either a physical or virtual display that is playing the content item, share metadata of the content item with the first remote XR device.

19. The system of claim 16, further comprising, the control circuitry configured to determine whether the first remote XR device is enrolled in a subscription plan with a service provider that is associated with providing the content item that will allow the first remote XR device to access a video stream associated with the content item from the service provider.

20. The system of claim 19, further comprising, the control circuitry configured to:
determine that the first remote XR device is not enrolled in the subscription plan with the service provider that will allow the first remote XR device to access the video stream associated with the content item; and
in response to determining that the first remote XR device is not enrolled in the subscription plan with the service provider, cause a transmission of a subscription offer related to the subscription plan to the first remote XR device for purchase.

21-30. (canceled)
